(19) United States
(12) Patent Application Publication
(10) Pub. No.: US 2014/0317453 A1
(43) Pub. Date: Oct. 23, 2014

(54) METHOD AND APPARATUS FOR DOCKING A TEST HEAD WITH A PERIPHERAL

(71) Applicants: Alyn R. Holt, Cherry Hill, NJ (US); Brian R. Moore, Cornwall (GB)

(72) Inventors: Alyn R. Holt, Cherry Hill, NJ (US); Brian R. Moore, Cornwall (GB)

(73) Assignee: INTEST CORPORATION, Mount Laurel, NJ (US)

(21) Appl. No.: 14/131,778

(22) PCT Filed: Jul. 11, 2012
(86) PCT No.: PCT/US2012/046182

§ 371 Date: Apr. 4, 2014

Related U.S. Application Data
(60) Provisional application No. 61/506,764, filed on Jul. 12, 2011.

(51) Int. Cl. G06F 11/22; G06F 13/40

(52) U.S. Cl. CPC G06F 11/221; G06F 13/409
USPC 714/44

(57) ABSTRACT

A method and apparatus for docking an electronic test head with a peripheral, which positions devices for testing. Exact-constraint alignment features, also sometimes known as kinematic features, are incorporated to provide repeatable positioning of the test head in three degrees of freedom with respect to the docking plane of the peripheral. A distinct alignment feature is used to provide planarity and to establish the required docked distance between the test head and the peripheral. The exact-constraint alignment features are mounted compliantly to enable them to position the test head in the plane while the test head is away from its final docked distance and to maintain that position as the test head is moved to its final docked position.

### FIELD OF THE INVENTION

The Invention relates to testing integrated circuits or electronic devices, and more particularly relates to docking a test head with a peripheral.

### BACKGROUND OF THE INVENTION

In the manufacture of integrated circuits (ICs) and other electronic devices, testing with automatic test equipment (ATE) is performed at one or more stages of the overall process. Special handling apparatus is used which places the device to be tested into position for testing. In some cases, the special handling apparatus may also bring the device to be tested to the proper temperature and/or maintain it at the proper temperature as it is being tested. The special handling apparatus is of various types including, for example, “probers” for testing unpackaged devices on a wafer and “device handlers” for testing packaged parts; herein, the terms “handling apparatus” or “peripherals” will be used to refer to all types of such apparatus. The electronic testing itself is provided by a large and expensive ATE system that includes a test head, which is required to connect to and dock with the handling apparatus. The Device Under Test (DUT) requires precision, high-speed signals for effective testing; accordingly, the “test electronics” within the ATE which are used to test the DUT are typically located in the test head which must be positioned as close as possible to the DUT. DUTs are continually becoming increasingly complex with increasing numbers of electrical connections. Furthermore, economic demands for test system throughput have led to systems that test a number of devices in parallel.

These requirements have driven the number of electrical connections between a test head and a peripheral into the thousands and the size and weight of test heads has grown accordingly. Presently, test heads may weigh from several hundred pounds to as much as two or three thousand pounds. The test head is typically connected to the ATE's stationary mainframe by means of a cable, which provides conductive paths for signals, grounds, and electrical power. In addition, the test head may require liquid coolant to be supplied to it by way of flexible tubing, which is often bundled within the cable. Further, certain contemporary test heads are cooled by air blown in through flexible ducts or by a combination of both liquid coolants and air. In the past, test systems usually included a mainframe housing power supply instruments, control computers and the like. Electrical cables couple the mainframe electronics to “pin electronics” contained in the test head. The cabling between the mainframe and the test head increases the difficulty of manipulating the test head precisely and repeatably into a desired position. Several contemporary systems now place virtually all of the electronics in the movable test head while a mainframe may still be employed to house cooling apparatus, power supplies, and the like. Thus, the increased number and spatial density of electrical contacts to be mated combined with the increased size and weight of the test head and its cable make it more difficult to accurately and repeatably position a test head with respect to a peripheral.

In testing complex devices, either individually or many in parallel, hundreds or thousands of electrical connections have to be established between the test head and the DUT or DUTs. These connections are usually accomplished with delicate, densely spaced contacts. In testing unpackaged devices on a wafer, the actual connections to the DUT or DUTs are typically achieved with needle-like probes mounted on a probe card. In testing packaged devices, it is typical to use one or more test sockets mounted on a “DUT socket board.” Herein, the term “DUT adapter” will be used to refer to the unit that holds the part or parts that make actual electrical connections to the DUT or DUTs. The DUT adapter must be precisely and repeatably positioned with respect to the peripheral in order that each of a number of DUTs may be placed, in turn, into position for testing.

Test systems may be categorized in terms of how the DUT adapter is held. Presently, in many systems the DUT adapter is fixed appropriately to the handling apparatus, which typically includes reference features to aid in accurately locating it. Herein, these systems will be referred to as “peripheral-mounted-DUT-adapter” systems. In other systems the DUT adapter is attached to the test head and positioned with respect to the handling apparatus by appropriately positioning (i.e., docking) the test head. These latter systems will be referred to as “test-head-mounted-DUT-adapter” systems. There are two possible subcategories of test-head-mounted-DUT-adapter systems. In the first subcategory, the DUT or DUTs are positioned before the test head is positioned or docked. Thus, the act of positioning the test head brings the connection elements into electrical contact with the DUT. This arrangement may be suitable for wafer scale testing, where the peripheral first positions a wafer and then the test head and DUT adapter (here a probe card configured to probe many or all of the devices on the wafer) is then positioned with respect to the wafer so that the needle-like probes contact the DUTs. In the second subcategory, the test head and DUT adapter are positioned or docked first, and this is followed by the peripheral moving DUTs in turn into position for testing as the DUT adapter remains in position.

It is to be noted that the DUT adapter must also provide connection points or contact elements with which the test head can make corresponding electrical connections. This set of connection points will be referred to as the DUT adapter electrical interface. Further, the test head is typically equipped with an electrical interface unit that includes contact elements to achieve the connections with the DUT adapter electrical interface. Typically, the test head interface contact elements are spring-loaded “pogo pins,” and the DUT adapter receiving contact elements are conductive landing pads. However, other types of connection devices may be incorporated for example for RF and/or critical analog signals. In some systems such other types of connectors are used in combination with pogo pins. The cumulative force required to compress hundreds or thousands of pogo pins and/or to mate other styles of contacts can become very high. This can be objectionable as the force required to bring the contacts into connection may be unreasonable and the force placed on the DUT adapter could cause undesirable deflections. Accordingly, alternative connection techniques, such as zero-insertion-force techniques, have been under development. For example, U.S. Pat. No. 6,833,696 (assigned to Xandex, Inc.) discloses a system having electrical contacts formed on substrates combined with mechanisms to bring corresponding contacts into engagement without placing undue force on a probe card or DUT board. It is further anticipated that in the future Micro Electromagnetic Machine (MEMs) techniques may be employed to form electrical contacts as an extension of their present use in fabricating probe cards. Overall, the contacts are very fragile and delicate, and they must be protected from damage.

In overview (more detailed descriptions will be provided further on) docking is the process of maneuvering the test head into position with respect to the peripheral for testing. In peripheral-mounted-DUT-adapter systems, docking includes properly and precisely conjoining the contact elements of the test head interface unit with their respective connection elements on the DUT adapter. In these systems, the delicate and fragile test head interface contacts must be afforded protection during the positioning and docking process. However, in test-head-mounted-DUT-adapter systems, the goal of docking is to precisely position and locate the DUT adapter with respect to the peripheral and/or DUTs. Also to be noted in test-head-mounted-DUT-adapter systems, the conjoining of the test head interface contact elements with the DUT adapter connection elements is accomplished when the DUT adapter is attached to the test head, and the contact elements are thus protected. However, the very delicate, needle-like probes of a probe card or the fragile, precisely manufactured test sockets are exposed during positioning and docking, and these too require protection.

Test head manipulators may be used to maneuver the test head with respect to the handling apparatus. Such maneuvering may be over relatively substantial distances on the order of one meter or more. The goal is to be able to quickly change from one handling apparatus to another or to move the test head away from the present handling apparatus for service and/or for changing interface components. When (as outlined above) the test head is held in a position with respect to the handling apparatus such that all of the connections between the test head the DUT adapter have been achieved and/or the DUT adapter is in its proper position, the test head is said to be “docked” to the handling apparatus. In order for successful docking to occur, the test head must be precisely positioned in six degrees of freedom with respect to a Cartesian coordinate system. Most often, a test head manipulator is used to maneuver the test head into a first position of coarse alignment within approximately a few centimeters of the docked position, and a “docking apparatus” is then used to achieve the final precise positioning.

Typically, a portion of the docking apparatus is disposed on the test head and the rest of it is disposed on the handling apparatus. Because one test head may serve a number of handling apparatuses, it is usually preferred to put the more expensive portions of the docking apparatus on the test head. The docking apparatus may include an actuator mechanism that draws the two segments of the dock together, thus docking the test head; this is referred to as “actuator driven” docking. The docking apparatus, or “dock” has numerous important functions, including: (1) alignment of the test head with the handling apparatus, including the precise alignment of electrical contacts, (2) sufficient mechanical advantage and/or actuator power to pull together, and later separate (i.e., undock), the test head and the handling apparatus, (3) providing pre-alignment protection for electrical contacts during both docking and undocking operations, and (4) latching or holding the test head and the handling apparatus together.

According to the in TEST Handbook (5^{th} Edition©1996, in TEST Corporation), “Test head positioning” refers to the easy movement of a test head to a handling apparatus combined with the precise alignment to the handling apparatus required for successful docking and undocking. A test head manipulator may also be referred to as a test head positioner. A test head manipulator combined with an appropriate docking means performs test head positioning. This technology is described, for example, in the aforementioned in TEST Handbook. This technology is also described in numerous patent publications, for example a partial list includes U.S. Pat. Nos. 7,728,579, 7,554,321, 7,276,894, 7,245,118, 5,931,048, 5,608,334, 5,450,766, 5,030,869, 4,893,074, 4,715,574, and 4,589,815 as well as WIPO publications such as WO05015245A2 and WO08103328A1, which are all incorporated by reference for their teachings in the field of test head positioning systems. The foregoing patents and publications relate primarily to actuator-driven docking. Test head positioning systems are also known where a single apparatus provides both relatively large distance maneuvering of the test head and final precise docking. For example, U.S. Pat. No. 6,057,695 to Holt et al., and U.S. Pat. Nos. 5,900,737 and 5,600,258 to Graham et al., which are all incorporated by reference, describe a positioning system where docking is “manipulator-driven” rather than actuator-driven. However, actuator-driven systems are the most widely used, and the present invention will be described in terms of such a system; however, those of reasonable skill will note that the invention is adaptable to manipulator-driven systems.

As previously stated, the goal of test head docking is to properly locate and position the test head with respect to the peripheral. The peripheral normally includes features, such as mounting surfaces that define a “peripheral docking plane.” The electrical contacts that connect to the DUT (and hence the DUT adpter, DUT socket board or probe card) must lie in a plane parallel to the peripheral docking plane. To facilitate docking, the docking apparatus that is mounted on the peripheral is typically located on a flat metallic plate that is attached to the peripheral such that its outer surface is parallel to the peripheral docking plane. Also the peripheral may include other reference features, such as precisely located pins or receptacles, to enable properly locating the DUT adapter.

Similarly, a “test-head docking plane” may be associated with the test head. The test head interface contact elements are typically arranged in a plane parallel to the test-head docking plane. A Cartesean coordinate system may be associated with either the test-head or peripheral docking plane such that the X and Y-axes lie in a plane parallel to the docking plane and the Z axis is perpendicular to the docking plane. Distances in the Z direction may referred to as height. It is to be noted that there may be more than one set of test head interface contact elements with the plane of each set being at a different height with respect to the docking plane. In the remainder of this document the term “docking plane” is used without a modifier it refers to the peripheral docking plane.

When properly docked, the test-head docking plane is substantially parallel to the peripheral docking plane. The process of achieving this relationship is often known as planarization and the result may be referred to as “docked planarity.” Also, when properly docked, the test head is at a predetermined preferred “docked distance” from the peripheral. Achieving docked planarity and docked distance requires three degrees of motion freedom of the test head, namely: rotations about axes parallel to the X and Y axes associated with the test-head docking plane and linear motion along the Z axis. Finally, when properly docked, the two docking planes will be aligned in the remaining three degrees of freedom corresponding to the X and Y directions as well as with respect to rotation about an axis parallel to the Z axis.

In the typical actuator-driven positioning system, an operator controls the movement of the manipulator to maneuver the test head from one location to another. This may be accomplished manually by the operator exerting force directly on the test head in systems where the test head is fully balanced in its motion axes, or it may be accomplished through the use of actuators directly controlled by the operator. In several contemporary systems, the test head is maneuvered by a combination of direct manual force in some axes and by actuators in other axes.

In order to dock the test head with the handling apparatus, the operator must first maneuver the test head to a “ready-to-dock” position, which is close to and in approximate alignment with its final docked position. The test head is further maneuvered until it is in a “ready-to-actuate” position where the docking actuator can take over control of the test head's motion. The actuator can then draw the test head into its final, fully docked position. In doing so, various alignment features provide final alignment of the test head. A dock may use two or more sets of alignment features of different types to provide different stages of alignment, from initial to final. It is generally preferred that the test head be aligned in five degrees of freedom before the fragile electrical contacts make mechanical contact. The test head may then be urged along a straight line, which corresponds to the sixth degree of freedom, that is perpendicular to the plane of the interface and peripheral docking plane.

As the docking actuator is operating (and while the dock alignment features are not imposing constraints), the test head is typically free to move compliantly in several if not all of its axes to allow final alignment and positioning. For manipulator axes which are appropriately balanced and not actuator driven, this is not a problem. However, actuator driven axes generally require that compliance mechanisms be built into them. Some typical examples are described in U.S. Pat. Nos. 5,931,048, 5,949,002, 7,084,358, and 7,245,118 as well as WIPO publication WO08137182A2 (all incorporated by reference). Often compliance mechanisms, particularly for non-horizontal unbalanced axes, involve spring-like mechanisms, which in addition to compliance add a certain amount of resilience or “bounce back.” Further, the cable connecting the test head with the ATE mainframe is also resilient leading to further bounce back effects. As the operator is attempting to maneuver the test head into approximate alignment and into a position where it can be captured by the docking mechanism, he or she must overcome the resilience of the system, which can often be difficult in the case of very large and heavy test heads. Also, if the operator releases the force applied to the test head before the docking mechanism is appropriately engaged, the resilience of the compliance mechanisms may cause the test head to move away from the dock.

U.S. Pat. No. 4,589,815 to Smith (incorporated by reference), discloses a prior art docking mechanism. The docking mechanism illustrated in FIGS. 5A, 5B, and 5C of the '815 patent uses two guide pin and receptacle combinations to provide final alignment and two circular cams. The guide pin receptacles are located in gussets that also hold cam followers which engage with the cams. To achieve a ready-to-actuate position, the cams must be fitted between the gussets such that the cam followers can engage helical cam slots located on the cams' cylindrical surfaces. Fitting the cams between the gussets provides a first, coarse alignment and also provides a degree of protection to the electrical contacts, probes or sockets as the case may be. When the cams are rotated by handles attached to them, the two halves of the dock are pulled together with the guide pins becoming fully inserted into their mating receptacles. A wire cable links the two cams so that they rotate in synchronism. The cable arrangement enables the dock to be operated by applying force to just one or the other of the two handles. The handles are accordingly the docking actuator in this case.

The basic idea of the '815 dock has evolved as test heads have become larger into docks having three or four sets of guide pins and circular cams. These are known as three-point and four-point docks respectively. FIGS. 1A and 1B of the present application illustrate a prior-art four-point dock having four gussets 116, four guide-pins 112, four complementary receptacles 112a and four circular cams 110. (This apparatus is described in more detail later.) Although such “four-point” docks have been constructed having an actuator handle 135 attached to one or more of the four cams 110, the dock shown in FIG. 1A incorporates a single actuator handle 135 that operates a cable driver 132. When the cable driver 132 is rotated by the handle 135, the cable 115 is moved so that the four cams 110 rotate in a synchronized fashion. Cams 110 engage cam followers 110a, which are attached to gussets 116. This arrangement places a single actuator handle in a convenient location for the operator. Also, greater mechanical advantage can be achieved by appropriately adjusting the ratio of the diameters of the cams to the diameter of the cable driver. In these docks, the interaction between the guide pins 112 and their corresponding receptacles 112a determines the position of the docked test head in three degrees of freedom in a plane parallel to the peripheral docking plane. As the cams 110 are rotated, the interaction between the cam followers 110a and the cam slots 129 control the remaining three degrees of freedom, namely the planarity of the test head with respect to the peripheral docking plane and the distance between the test head and the peripheral 108. When the cams 110 have been fully rotated, the gussets 116, which are attached to the peripheral 108, bear against the test head 100, establishing the final “docked distance” between test head 100 and peripheral 108 as well as the final “docked planarity” of the test head.

Other prior art docks, such as those manufactured by Reid Ashman, Inc., are similar in concept but utilize linear cams in lieu of circular cams and solid links instead of cables to synchronously drive the cams. Another scheme that utilizes linear cams but which is actuated by pneumatic elements is described in U.S. Pat. No. 6,407,541 to Credence Systems Corporation (incorporated by reference). In the '541 patent, “docking bars” serve a similar purpose to the previously described “gussets.”However, when the test head is docked, the docking bars do not bear against the unit being docked to; thus, the interaction between the cam followers and the cams solely determines the docked distance and docked planarity.

Still other variations of docks are known. For example, a partially automated dock that may be operated in either partially or fully powered modes and which incorporates cable-driven circular cams is disclosed in U.S. Pat. Nos. 7,109,733 and 7,466,122 (both incorporated by reference), both to the present assignee. A further dock configuration including solid link driven circular cams and which may be powered is described in WIPO publication WO2010/009013A2 (incorporated by reference), also to the present assignee. These docks utilize guide pins and receptacles to establish position within the plane and gussets or the equivalent to establish docked planarity and the docked distance between the test head and the peripheral.

Additionally, the docks described in U.S. Pat. Nos. 5,654,631 and 5,744,974 utilize guide pins and receptacles to align the two halves. However, the docks are actuated by vacuum devices, which urge the two halves together when vacuum is applied. The two halves remain locked together so long as the vacuum is maintained. However, the amount of force that can be generated by a vacuum device is limited to the atmospheric air pressure multiplied by the effective area. Thus, such docks are limited in their application.

U.S. Pat. Nos. 7,235,964 and 7,276,895 (both incorporated by reference) to the present assignee describe docks that use relatively large alignment pins (as illustrated in FIG. 14 of the '895 patent), which are typically attached to the peripheral. The diameter of the pins is relatively narrow at their distal ends and is larger at the interior ends. Also, two cam followers are attached to the pins near the point where they are attached to the peripheral. Camming mechanisms, employing linear cams, are attached to the test head. The distal ends of the alignment pins may be first inserted into the camming mechanisms to provide a first stage of course alignment. As the test head is urged closer to the peripheral, the larger diameter enters the camming mechanism to provide closer alignment. As the test head is further urged towards the peripherals, the cam followers eventually engage the cams, which may then be actuated to pull the two halves into a final docked position. No gussets are involved; the docked distance and docked planarity are solely determined by the interaction between the cams and cam followers. Further, it is necessary for the camming mechanisms to serve as pin receptacles, providing sufficient interaction with the pins to position the test head in three degrees of freedom parallel to the peripheral docking plane.

In all of the docks that have been mentioned, including both actuator driven and manipulator driven, alignment of the test head within a plane parallel to the docking plane is determined by the fit of guide pins within their respective receptacles. In order to facilitate many cycles of docking and undocking, the guide pins are usually designed to have a diameter that is a few thousandths on an inch smaller than that of their receptacle. Thus the accuracy and repeatability of the final docked position of the test head is limited to at least typically three to five thousandths of an inch with respect to the peripheral docking plane. While this has been acceptable for many past and contemporary test systems, the demand for systems having greatly improved accuracy and especially repeatability is expected to grow.

As previously indicated, the purpose of docking in a peripheral-mounted-DUT-adapter system is to precisely mate the test head electrical interface with the DUT adapter electrical interface. Each electrical interface and defines a plane, which is typically, but not necessarily, nominally parallel with the distal ends of the electrical contacts. When docked these two planes must be parallel with one another. Normally, the DUT adapter is fabricated as a planar circuit board and is desirably fixed to the peripheral in a plane parallel to the peripheral's docking plane. Thus, when docked, the plane of the test head electrical interface must also be parallel to the peripheral docking plane. In order to prevent damage to the electrical contacts, it is preferred to first align the two interfaces in five degrees of freedom prior to allowing the electrical contacts to come into mechanical contact with one another. If in the docked position the defined planes of the interfaces are parallel with the X-Y plane of a three-dimensional Cartesian coordinate system, alignment must occur in the X and Y axes and rotation about the Z axis (Theta Z or Yaw), which is perpendicular to the X-Y plane, in order for the respective contacts to line up with one another. Additionally, the two planes may be made parallel by rotational motions about the X and Y axes (Pitch and Roll). The process of making the two electrical interface planes parallel with one another is called “planarization” of the interfaces; and when it has been accomplished, the interfaces are said to be “planarized” or “co-planar.” Once planarized and aligned in X, Y and Theta Z, docking proceeds by causing motion in the Z direction perpendicular to the peripheral docking plane.

Similarly, the purpose of docking in test-head-mounted-DUT-adapter systems is to precisely position the test head so that the DUT adapter is properly located with respect to the peripheral. The DUT adapter's probe tips or socket contacts constitute an electrical test interface, which defines a plane that must be planarized with the peripheral's docking plane. Further, the electrical test interface must be precisely aligned with respect to the X and Y axes of the docking plane and with respect to rotation about the Z axis. As with the previous case, it is preferred that alignment in these five degrees of freedom occurs before final positioning in the Z direction.

In the process of docking, the test head is first maneuvered into proximity of the peripheral. Further maneuvering brings the test head to a “ready to dock” position where, in many systems, some first coarse alignment means is approximately in position to be engaged. Still further maneuvering will bring the test head to a “ready to actuate position,” where the docking mechanism may be actuated. At the ready to actuate position, approximate planarization and alignment in X, Y and Theta Z have been achieved. As the dock is actuated, alignment and planarization become more precise. With further actuation, alignment and planarization are finalized to a degree of accuracy determined by the alignment features. This is then followed by continued motion in the Z direction, bringing the test head into its final docked position. Further details with regards to specific selected docks are described in the detailed description of the invention, to follow. It is noted that in manipulator driven docking, as described in the previously mentioned U.S. Pat. Nos. 6,057,695, 5,900,737 and 5,600,258, sensors detect the equivalent of a ready to actuate position in order to change from a coarse positioning mode to a fine positioning mode. Thus, to one of ordinary skill in the art, sensing a ready to actuate position in an actuator-driven dock would be a natural extension (intuitive and obvious) of what is taught and disclosed by the '695, '737 and '258 patents.

Docks of the types described above have been used successfully with test heads weighing up to and over one thousand pounds. However, as test heads have become even larger and as the number and spatial density of contacts has exponentially increased, a number of problems have become apparent. Immediately apparent is the increased demand for positional accuracy and repeatability. Further, the force required to engage the contacts and maintain them in position increases as the number of contacts increases. Typically a few ounces per contact is required; thus docking a test head having 1000 or more contacts requires in excess of 100 or 200 pounds for this purpose. In view of the present few thousandths of an inch “slop” in dock design, these forces combined with the relatively unpredictable bounce-back effects due to the resilience in the manipulator compliance mechanism and the test head cable make it increasingly difficult to repeatability and accurately perform test-head docking.

### SUMMARY OF THE INVENTION

The field of “exact-constraint” or “kinematic” couplings, which, through the works of Lord Kelvin and James Clerk Maxwell, dates to the mid 19^{th} century or before, offers techniques for providing rigid and repeatable connections or couplings between two objects. Such techniques when applied to test-head docking, may provide improved accuracy and repeatability. A number of texts, academic papers, commercial publications, patent publications, and internet-published presentations provide information on the design and application of kinematic couplings. General principles of kinematic couplings may be found in the following references, each of which is incorporated herein by reference:
Texts—Hale, Layton Carter, Principles and Techniques for Designing Precision Machines, UCRL-LR-133066, Lawrence Livermore National Laboratory, 1999, https://e-reports-ext.llnl.gov/pdf/235415.pdf.; Slocum, A. H., Precision Machine Design, Prentice Hall, Englewood Cliffs, N.J., 1992; Smith, S. T., Chetwynd, D. G., Foundations of Ultraprecision Mechanism Design, Gordon and Breach Science Publishers, Switzerland, 1992.

Technical Papers—Hart, A. J., Slocum, A. H., Willoughby, P., “Kinematic Coupling Interchangeability,” Precision Engineering, 2004, 28:1-15; Slocum, A. H., “Design of Three-Groove Kinematic Couplings,” Precision Engineering, April 1992, Vol. 14, No. 2, pp 67-76; Culpepper, M. L., “Design of Quasi-Kinematic Couplings,” Precision Engineering, 2008: 338-357; Slocum, A. H. and Donmez, A, “Kinematic Couplings for Precision Fixturing—Part 2: Experimental determination of repeatability and stiffness,” Precision Engineering, July 1988, Vol. 10, No. 3; U.S. Pat. No. 5,678,944 to A. H. Slocum, et al.
Commercial Literature—Ball-tek, Div. Of Micro Surface Engr., Inc., Los Angeles, Calif., Commercial Website, http://www.precisionballs.com.; Ball-tek, Div. Of Micro Surface Engr., Inc., “An Introduction to Kinematics and Applications, Kinematic Components,” http://www.precisionballs.com/Introduction_to_Kinematics_and Applications.htm.; Ball-tek, Div. Of Micro Surface Engr., Inc., “Micro Inch Positioning with Kinematic Components,” http://www.precisionballs.com/Micro_Inch_Positioning with_Kinematic_Components.html.; Ball-tek, Div. Of Micro Surface Engr., Inc., “The Kinematic Encyclopedia,” http://www.precisionballs.com/KINEMATIC ENCYCLOPEDIA.htm.; g2 engineering, Mountain View, Calif., Commercial Website, http://www.g2-engineering.com.; g2 engineering, Mountain View, Calif., “Application Notes,” http://www.g2-engineering.com/spherolinder-applications.html; g2 engineering, Mountain View, Calif., “g2 Engineering Catalog.” http://www.g2-engineering.com/spherolinder-catalog.html.

Further, companies such as Ball-tek, Div. Of Micro Surface Engr., Inc., Los Angeles, Calif. (http://www.precisionballs.com), and g2 engineering (formerly Gizmonics, Inc.), Mountain View, Calif. (http://www.g2-engineering.com), supply a variety of components for the purpose of constructing kinematic or exact-constraint type couplings and apparatus. Herein, as an aid to understanding the present invention, we provide a brief overview of the basics of the field.

Definitions of “kinematic coupling” vary somewhat from work to work; also the term “kinematic” is used to describe other types of mechanical designs. Thus, some authors prefer to use terms such as “exact constraint” or “deterministic” as replacements or modifiers. In the remainder of this disclosure the terms exact-constraint and kinematic will be used interchangeably and often together. Briefly the terms kinematic or exact-constraint couplings refer to couplings between objects that constrain relative motion and hence position in desired degrees of freedom, usually without redundancy or over constraint, and that require a force to urge and hold the objects together. An important benefit of the technique is that it allows repeatability that may exceed by orders of magnitude the tolerances to which the components of the coupling are fabricated.

Characteristics of kinematic/exact-constraint couplings include alignment features that engage at discrete points of contact, such as a spheroidal surface contacting a planar surface or two spheroidal surfaces contacting one another. Generally, provided that the contact points are properly disposed, one point of contact is necessary to constrain each desired degree of freedom. Thus, six points of contact are sufficient to constrain six degrees of motion freedom. In other situations, features that provide discrete lines of contact may be utilized; these are sometimes, but not always, referred to as “quasi-kinematic.” Depending on the configuration, a line of contact may replace one or more points of contact. A line of contact may also somewhat over constrain the system, thereby somewhat reducing the potential repeatability.

There are two basic or traditional configurations of exact-constraint/kinematic couplings, which are depicted in FIGS. 18A and 18B (which follow FIGS. 6-4(a) and (b) in [L. C. Hale]). The first, FIG. 18A, historically is usually referred to as a “Kelvin Clamp,” due to Lord Kelvin. Here three spherically shaped units 1821, 1822, 1823 are attached to the first object 1810. The first sphere 1821 contacts a flat surface 1831 on the second object 1830 making a single point of contact; the second sphere 1822 contacts a Vee-groove 1832 on the second object 1830 at two points; and the third sphere 1823 contacts an open, inverted tetrahedron 1833 (shown as three vertical posts with sloped ends forming three sides of a tetrahedran) on the second object 1830 at three points. Thus, six points of contact are provided, constraining six degrees of relative motion freedom between the two objects. Oftentimes the inverted tetrahedron is replaced by an inverted cone or cup shape, providing a circular line of contact with the mating spherical shape. The latter situation may be regarded as being easier to fabricate. Kelvin Clamps are frequently used in adjustable optical component holders such as Techspec® “Kinematic Circular Optical Mounts” available from Edmund Scientific, Barrington, N.J.

The second configuration shown in FIG. 18B, apparently due originally to Maxwell, is sometimes known as a “ball and groove” configuration or as a “three-Vee” configuration. Here, three spherically shaped units 1851, 1852, 1853 are attached to the first object 1850; and three corresponding Vee-grooves 1861, 1862, 1863 are disposed on the second object 1860 so that the three spheres may fit within respective grooves providing two contact points per groove-sphere combination. The three-Vee configuration is used in numerous applications including, for example, specimen holders in microscopy, workpiece holders in machining, molds, and probes in coordinate measuring machines.

As an aid to further discussion some further general information and terminology is now introduced. Usually a kinematic coupling includes a number of pairs of features. One member of each pair is attached to the first of the units to be coupled and the other member is attached to the other unit. Thus, in the three-Vee coupling there are three pairs of ball-groove combinations, with the balls being attached to one unit and the grooves to the other. More generally each member of the pair includes one or more surfaces, and the surfaces are designed such that when they are engaged with one another they make contact at discrete points or along discrete lines. To aid in discussion the surface(s) of one member of a pair may be referred to as “contact surface(s),” and the surface(s) of the other member may be referred to as “mating surface(s).” Thus each side of a groove in a three-Vee coupling could be called a contact surface, and the ball could be called the mating surface (or vise versa). Other shapes may be used to form surfaces; for example a gothic arch could be used in place of a flat-sided Vee-groove. It is also not necessary that a ball be used as a mating surface. Other shapes, such as the tip of a cone, can be made to contact a surface at a single point or along a line. Examples of other pairs of surfaces include a ball pressing against a flat surface providing a single point of contact and a ball pressing against a tetrahedron providing three points of contact as previously described with regards to the Kelvin Clamp configuration. Yet another possibility is a ball pressing against three balls providing three points of contact. Different types of contacts may be used in one coupling as long as they are sufficient to control the desired degrees of freedom.

Numerous other configurations of exact-constraint/kinematic couplings are known, many employing alternatively shaped features for various purposes and applications. The reader is referred to the previously listed publications and component suppliers such as the aforementioned Ball-tek and g2 engineering for further information. However, further details regarding exact-constraint/kinematic couplings will be presented as needed and/or appropriate in this specification. Also included for its teachings is U.S. Pat. No. 5,678,944, which describes a “flexural mount” kinematic coupling; various aspects of this disclosure are also mentioned in the present specification as appropriate. It is important to note that the alignment features used in the previously described prior art docks are not of this type because they are designed to have a certain amount of “slop” to facilitate repetitive docking and undocking with minimal effort; and, thus, are not motion or position constraining. In this regard, we may refer to alignment features that use exact-constraint/kinematic coupling principles as “position-constraining” features.

It is also worthy to note that while six points of contact may be sufficient to constrain a rigid object in six degrees of freedom, additional constraints may be necessary in situations where one or both of the objects being coupled is subject to flexing under load.

Exact-constraint or kinematic coupling techniques have also been employed in certain test systems and test system apparatus. For example the apparatus disclosed in U.S. Pat. Nos. 5,821,764, 5,982,182, and 6,104,202 (all included by reference) use three-Vee kinematic coupling techniques to provide the final alignment between the two halves. Coarse alignment pins may also be included to provide an initial alignment. The coarse alignment pins may be provided with a catch mechanism, which captures the guide pin in its hole and prevents it from escaping. The catch mechanism appears to activate automatically in the '764 and '202 patents; whereas, a motor driven device is utilized for each of the three coarse alignment pins in the '182 patent. Also in the '182 patent, the three motors may be operated separately to effect planarization between the docked components. In all three patents, a linear actuator is used to finally pull the two halves together. The linear actuator is disclosed as being of the pneumatic type. In docks of this type, it is necessary that another mechanism be used to provide enough pre-alignment to prevent damage to the fragile electrical contacts. For this reason the aforementioned coarse alignment pins are used. Thus, two sets of alignment features are provided, namely: (1) coarse-alignment, loose fitting pin-receptacle combinations, and (2) a kinematic coupling. Although kinematic couplings provide highly precise repeatability in positioning two entities, a difficulty with docks of the type described in the '764 and '202 patents is that initially adjusting the kinematic coupling components so that the necessary positional accuracy in all six degrees of freedom can be burdensome. That is, the positions of the Vee-grooves and balls must be carefully calibrated to control X,Y and rotational position in the docking plane as well as the final docked distance and docked planarity of the two halves. However, the separate control of the actuators in the '182 patent enable a means of independently adjusting the docked planarity and docked distance parameters.

Yet another example of the use of kinematic coupling techniques is in U.S. Pat. No. 6,833,696 (to Xandex, Inc.) and its siblings (all included by reference), which disclose a test system docking mechanism. In this system, three spherical balls are compliantly attached to the test head side with spring mechanisms. Three Vee-groove units, also attached to the test head, are located between the balls and the test head. In an undocked position, the balls do not contact these Vee-grooves. A second set of three Vee-grooves is attached to the peripheral side. In docking, coarse alignment means are used to guide the test head and three balls into proximity to the grooves mounted on the peripheral, and an actuator is connected to pull the test head further towards the peripheral. The balls then engage the peripheral set of grooves. As the actuator further moves the test head, the balls move against the compliance towards the test head until they finally become sandwiched between the two sets of grooves, which defines the final docked position. In this system, calibration of the final docked position requires the adjustment of two opposing sets of three grooves and one set of three compliantly mounted spheres. Furthermore, the system, having a total of 12 points of contact, appears to be disadvantageously over-constrained. In such an over-constrained system, one set of contacts could “fight” another resulting in degraded repeatability.

Still another example is provided by U.S. Pat. No. 5,828,225 to Tokyo Electron Limited of Japan. The disclosed system includes apparatus for locating a test head with respect to a wafer prober. An exact-constraint coupling technique is used as next summarized. Three spherical units are mounted on the test head, disposed at the corners of an approximate equilateral triangle. Two Vee-groove units are disposed on the peripheral so as to receive two of the spherical units. An inverted cone is disposed on the peripheral so as to receive the third spherical unit with a circular line of contact. Thus, a (somewhat over-constrained) six-degree-of-freedom constraining coupling is provided. The two Vee-groove units are mounted on actuators, which are attached to the peripheral. The actuators are configured to move the Vee-grooves linearly in the Z-direction; i.e., towards or away from the test head. The inverted cone is not movable in the Z-direction. The actuators may be controlled by a controller to adjust the height of each Vee-groove to establish planarity between the two halves in response to information sensed by an appropriate sensing apparatus. While such adjustment takes place, the test head may pivot about the third sphere, located within the inverted cone feature.

As noted, it is necessary that a force is applied to urge the features together and to maintain the contact. This is known as a “preload” force. In some circumstances gravity may serve as a preload force. In other circumstances, specific apparatus such as springs may be used. The preload force produces reaction forces at the points or lines of contact between the surfaces. Components of these reaction forces may lie in a plane and in directions to constrain the relative position of the objects being coupled. The forces that may be applied to a kinematic coupling may be high enough to cause Herzian deformations at the points or lines of contact, transforming them to areas of contact and possibly degrading repeatability over time and operation cycles.

The inventors have recognized that it would be desirable to retain this simplicity and proven techniques in a highly precise dock having positional constraint for large test heads. The cam-actuated docks, mentioned previously and to be described in more detail later, combine pre-alignment with gussets and cams, close alignment in the docking plane with guide pins and receptacles, docking planarization and distance control by the cams and gussets, and mechanical advantage and locking with cams and cam followers, all using relatively simple mechanisms. Highly precise docking is achieved utilizing compliant position constraining features.

### BRIEF DESCRIPTION OF THE DRAWINGS

FIG. 1A is a perspective view of a prior art test head and peripheral with docking apparatus added.

FIG. 1B is an enlarged perspective view of the peripheral shown in FIG. 1A with a coordinate system added for reference.

FIG. 2A is a perspective view of a typical gusset.

FIG. 2B is a perspective view of a typical circular cam.

FIGS. 3A, 3B, 3C and 3D are side and partial-cross-section views of a sequence of stages in the docking the test head of FIG. 1A with the peripheral of FIG. 1A.

FIG. 4 illustrates an exemplary cam groove.

FIG. 5A is a perspective of an exemplary test head and peripheral with exemplary docking apparatus added according to the invention.

FIG. 5B is an enlarged perspective view of the peripheral shown in FIG. 5A with a coordinate system added for reference.

FIG. 6A is a perspective view of an exemplary Vee-groove feature block.

FIG. 6B is a perspective view of an exemplary compliant feature unit.

FIG. 6C is an exploded view of the exemplary compliant feature unit shown in FIG. 6B.

FIG. 6D is a cross-sectional view of the housing of the exemplary compliant feature unit shown in FIG. 6B.

FIG. 7 is cross-sectional view of the exemplary compliant feature unit coming into contact with the exemplary Vee-groove feature.

FIGS. 8A, 8B, 8C, 8D, 8E, 8F, 8G, and 8H are side and partial-cross-section views of a sequence of stages in the docking the test head of FIG. 5A with the peripheral of FIG. 5A.

FIG. 9A is a perspective of a second exemplary test head and peripheral with a second exemplary docking apparatus added according to the invention.

FIG. 9B is an enlarged perspective view of the peripheral shown in FIG. 9A with a coordinate system added for reference.

FIG. 10A is a perspective view of an inverted-cone feature block.

FIG. 10B is a perspective view of a compliant feature unit's piston shaft that includes tetrahedron feature at its distal end.

FIG. 11A is a perspective of a third exemplary test head and peripheral having a third exemplary docking apparatus added according to the invention.

FIG. 11B is an enlarged perspective view of the peripheral shown in FIG. 11A.

FIG. 11C is an enlarged perspective view of the test head shown in FIG. 11A.

FIG. 12A is a perspective view of a compliant feature unit's piston shaft that includes an inverted cone feature at its distal end.

FIG. 12B is a perspective view of a tetrahedronal feature block.

FIG. 12C is a cross-sectional view of the piston shaft of FIG. 12A close to being in contact with the tetrahedronal feature block of FIG. 12B.

FIGS. 13A, 13B and 13C are side and partial-cross-section views of a sequence of stages in the docking the test head of FIG. 11A with the peripheral of FIG. 11A.

FIG. 14 is a perspective view of a fourth exemplary test head and peripheral where the DUT adapter is a socket board mounted to the test head.

FIGS. 15A, 15B, and 15C are side and partial-cross-section views of a sequence of stages in the docking the test head of FIG. 15 with the peripheral of FIG. 14.

FIG. 16 is a flow chart illustrating steps in a method of docking.

FIG. 17 is a flow chart illustrating a generalized method for providing compliant position-constraining coupling features.

FIG. 18A is a view illustrating a prior art “Kelvin clamp” type of exact-constraint or kinematic coupling.

FIG. 18B is a view illustrating a prior art “ball and groove” or “three-Vee” type of exact-constraint or kinematic coupling.

### DETAILED DESCRIPTION OF THE INVENTION

The invention provides significant improvement to the accuracy and repeatability that is available in contemporary and prior art docks. Accordingly, the details of a typical, exemplary prior art docking system will first be described. This will be followed by a description of an exemplary embodiment of the invention utilized in conjunction with a similar docking system. Additional exemplary embodiments and applications of the invention will also be discussed, and a novel method of docking illustrated by these embodiments will be described. It is to be understood that numerous styles and configurations of docking apparatus are known (many of which having been previously mentioned) and that one of ordinary skill in the art may be expected to be able to readily apply the inventive concepts to such systems. As the discussion proceeds, a number of alternatives will be mentioned, but these are not meant in any way to be limiting to the scope of the invention. The description is done with the aid of the figures which are intended to be illustrative and are not necessarily drawn to scale nor are they intended to serve as engineering drawings.

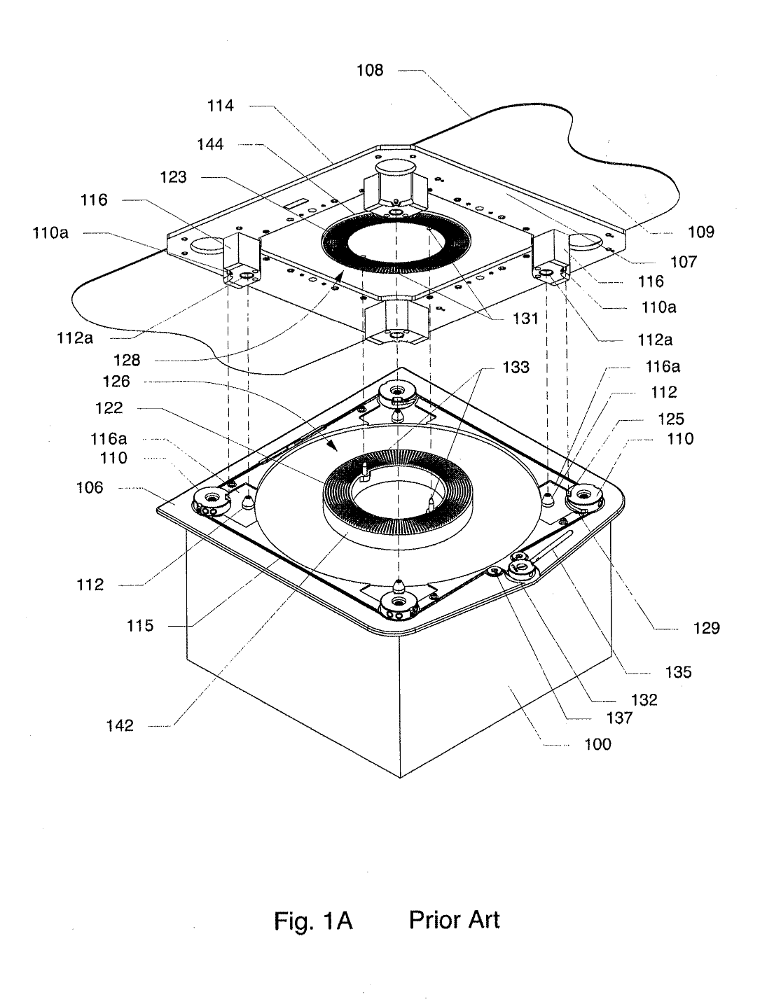

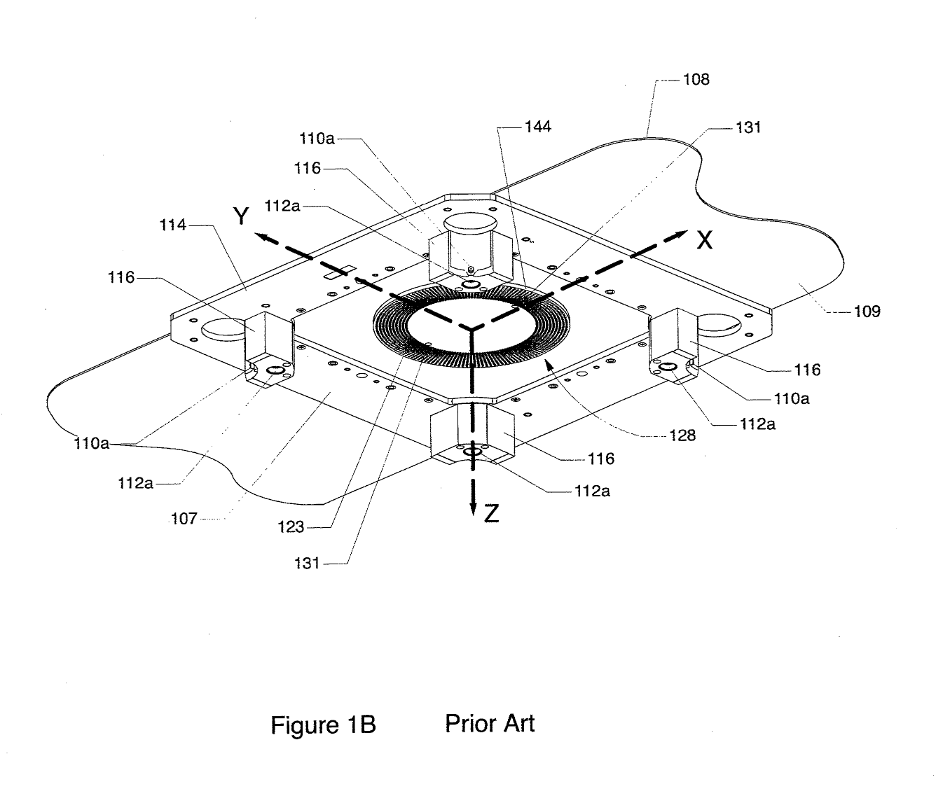

To begin, selected details of an exemplary prior art dock are illustrated in FIGS. 1A and 1B, FIGS. 2A and 2B, and FIGS. 3A through 3D. This dock was previously mentioned under the Background of the Invention and it will next be described in some detail. This dock and the related description includes aspects from an earlier docking apparatus described in the previously mentioned U.S. Pat. No. 4,589,815, which is incorporated by reference.

FIG. 1A shows in perspective a test head 100, which is typically held in a cradle (not shown) that is in turn supported by a test head manipulator (not shown). Also shown is a cut-away segment of a handler apparatus 108 to which test head 100 may be docked. DUT adapter 144 is attached to handler apparatus 108; thus the system is a peripheral-mounted-DUT-adapter system. In this particular example the handler apparatus 108 may be a packaged device handler and DUT adapter 144 may be a DUT socket board. The test head 100 is docked to handler apparatus 108 from below with a generally upward motion. Other orientations are possible and known, including, but not limited to: docking to a top surface with a downward motion, to a vertical plane surface with horizontal motion, and to a plane that is at an angle to both the horizontal and vertical. Typically, docking to a top surface is used when the handler apparatus is a wafer prober; while all of the configurations are most typically used with package handlers of varying styles. FIG. 1B shows device handler 108 in somewhat larger scale and greater detail. Handler apparatus 108 includes planar outer surface 109. FIG. 1B includes in broken lines mutually perpendicular axes X, Y and Z, which form a right-handed Cartesian coordinate system. The X and Y axes lie in a plane which is parallel to the outer surface 109 of handler apparatus 108 and also parallel to the plane defined by DUT adapter 144. These planes are parallel to the previously defined peripheral docking plane.” The Z-axis represents the perpendicular distance from DUT adapter 144. Rotations about an axis parallel with the Z-axis are referred to as “theta Z” motion.

Referring to FIG. 1A, signal contact ring 142, which includes test-head electrical interface 126, is coupled to test head 100. Electrical interface 126 provides electrical connections to the testing electronics within test head 100. Handler apparatus 108 has coupled to it a corresponding DUT adapter 144, which includes electrical interface 128. In package handlers, DUT adapter 144 often includes one or more test sockets. These test sockets are for holding and making electrical connections to the device or devices under test; and DUT adapter 144 is thus often referred to as a DUT socket board or more simply as a “DUT board” or “socket board.” In wafer probers, DUT adapter 144 may be a “probe card” that includes needle like probes for making electrical connections to unpackaged devices included on a wafer. The DUT contacting elements, either probes or sockets, are located on the opposite side of the board from electrical interface 128, which provides electrical connections to either the test socket(s) or probes as the case may be, and are thus not visible in FIGS. 1A and 1B. Electrical interfaces 126 and 128 typically have hundreds or thousands of tiny, fragile electrical contacts (not clearly shown) that must be respectively and precisely joined together (i.e., conjoined) in a manner to provide reliable corresponding individual electrical connections when the test head is finally docked. In a typical, contemporary situation the contacts within test-head electrical interface 126 are tiny spring loaded “pogo” pins 122, and the corresponding contacts on DUT-adapter electrical interface 128 are conductive landing pads 123. (Pogo pins 122 and landing pads 123 are not individually distinguishable in FIGS. 1A and 1B due to the scale.) Various other types of contacting devices may also be included as need be for special signals such as radio frequency and low level analog signals. As is shown in this exemplary case, the lower surface 109 of handler apparatus 108 contains the handler electrical interface 128, and the test head 100 is docked with a generally upward motion from below.

Handler apparatus 108 includes reference features 131, which in this case may be bushing-lined holes disposed at precise locations with respect to its lower surface 109. The inside diameter of the bushing may typically be approximately ¼ inch to ⅜ inch. Reference features 131 are for properly aligning DUT adapter 144 with handler apparatus 108 so that the handling apparatus's positioning mechanism can effectively place DUTs in contact with the test socket(s) or probes. For example, DUT adapter 144 may be designed with corresponding holes so that temporary dowel pins can hold DUT adapter 144 in position while it is fastened to handler apparatus 108 with appropriate fasteners. Once it is fastened, the temporary dowels may be removed, if desired. Furthermore, reference features 131 may be utilized to align signal contact ring 142 with handler apparatus 108 and DUT adapter 144. Thus, corresponding reference pins 133 are mounted on signal ring 142. To facilitate relatively easy insertion, the full diameter of reference pins 133 is typically a few thousandths of an inch less than the inside diameter of the bushings of reference features 131. Also, reference pins 133 are normally tapered at their distal ends. These two properties facilitate their entry into and a sliding fit with respect to the bushings of corresponding reference features 131. Preferably, the apparatus is designed so that when reference pins 133 are fully conjoined with reference features 131, the electrical contacts of electrical interface 126 are aligned with and in full conductive contact with their corresponding respective electrical contacts of interface 128. A primary goal of docking is to maneuver test head 100 into a position that provides such alignment and to maintain that position while testing.

Although a specific configuration of reference features has been described, those familiar with the field will recognize that other arrangements are both possible and in use. For example, the locations of reference pins and receptacles could be reversed with the pins placed on the peripheral side and receptacles incorporated on the test head side. The essential role of the reference features is to aid in the initial set up of the docking apparatus by providing initial alignment to within a few thousandths of an inch between the two halves. Once that has been achieved, their use for alignment in repetitive docking operations may be optional, provided that the docking apparatus has equivalent or superior alignment means. The locations of the reference features may also vary. To illustrate, in certain instances the peripheral-side reference features may be integral to the peripheral as described above with respect to FIGS. 1A and 1B; however, in other instances they may be included on the DUT adapter, which has been previously aligned with the peripheral during its installation. The locations of the reference features on the test head side could similarly vary. The details of the actual reference features are not essential to the invention to be described. Thus, in the embodiments to be described reference numbers 131 and 131′ will be used to indicate generic peripheral-side reference features, and reference numbers 133 and 133′ will be used to indicate generic test-head-side reference features. It will be further recognized that the features shown are generic in nature, and that other types could be readily substituted without any loss of generality in describing the invention.

Still referring to FIGS. 1A and 1B, a four-point docking apparatus is shown; portions of it are attached either to the handler apparatus 108 or to the test head 100. Attached to test head 100 is faceplate 106. Four guide pins 112 are attached to and located near the four corners of faceplate 106. Face plate 106 has a central opening and is attached to test head 100 so that the test head signal contact ring 142 and electrical interface 126 are accessible. Guide pins 112 define an approximate rectangle that has an approximate common center with electrical interface 126. Faceplate 106 and electrical interface 126 preferably lie in parallel planes.

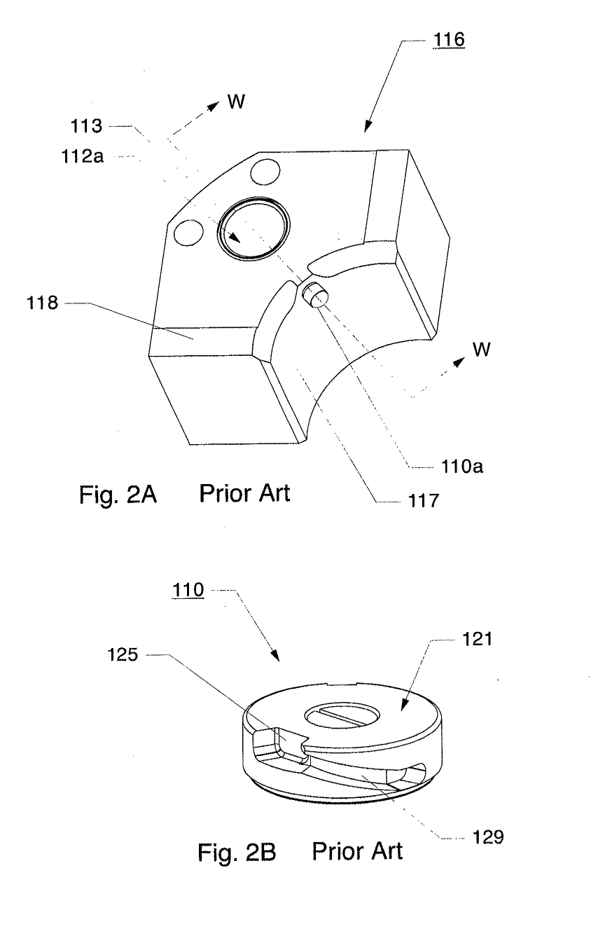

Gusset plate 114 is attached to the exterior surface 109 of handler apparatus 108. Gusset plate 114 is mounted so as to be parallel with the peripheral docking plane of handler apparatus 108. Gusset plate 114 has a central opening and is attached to handler apparatus 108 so that DUT adapter 144 and electrical interface 128 are accessible. Four gussets 116 are attached to gusset plate 114, one located near each of its four corners. A typical gusset is shown in FIG. 2A. Each gusset 116 has a planar surface 118, which is parallel to gusset plate 114. When docked each planar surface 118 is in contact with a respective landing area 116a on faceplate 106 establishing both docked planarity and docked distance between gusset plate 114 and faceplate 106. Further, each gusset 116 has a hole 112a bored in it, preferably partially lined with a precision bushing 113. Hereinafter the combination will be referred to as a guide pin receptacle 112a. Each guide-pin receptacle 112a corresponds to a respective guide pin 112. These are arranged so that when the test head 100 is fully docked, each guide pin 112 will be fully inserted into its respective guide-pin receptacle 112a. The fit of each guide pin 112 in its corresponding guide-pin receptacle 112a typically provides a fit to within a few thousandths of an inch. Thus, the guide pins 112 and guide-pin receptacles 112a provide alignment to within a few thousandths of an inch between the test head 100 and the handler apparatus 108.

Four docking cams 110 are rotatably attached to test-head face plate 106. Cams 110 are circular and are similar to those described in the '815 patent. A typical cam is shown in FIG. 2B. In particular each has a side helical groove 129 on its circumference with an upper cutout 125 on the upper face 121. Each docking cam 110 is located in proximity to a respective guide pin 112 such that it is generally centered on a line extending approximately from the center of the test head electrical interface 126 through the respective guide pin 112 and such that guide pin 112 lies between cam 110 and the test head electrical interface 126. Gussets 116 have circular-arc cutouts 117 so that when guide pins 112 are fully inserted into guide-pin receptacles 112a in gussets 116, the circumference of each cam 110 is adjacent to and concentric with the circular-arc cutout 117 in its respective gusset 116. The heights of cams 110 and guide pins 112 are approximately the same, defining a plane that is parallel to face plate 106. The interference provided by the interaction of gussets 116 with cams 110 and guide pins 112 as the test head is maneuvered into position provides protection for the delicate electrical contacts. Extending from the circular-arc cutout 117 of each gusset 116 is a cam follower 110a. Each cam follower 110a fits into the upper cutout 125 on the upper face of its respective cam 110. This arrangement provides protective initial course alignment to within approximately ⅛ to ¼ inch between the docking components as the test head 100 is first maneuvered into position for docking with handler apparatus 108. This initial coarse alignment allows the tapered ends 111 of guide pins 112 to enter their respective receptacles 112a. The gussets 116, cams 110, and guide pins 112 are arranged so that DUT adapter electrical interface 128 is kept separated from test head electrical interface 126 until after the full diameters of guide pins 112 are actually received in their respective guide-pin receptacles 112a. Accordingly, pre-alignment protection is provided to the electrical contacts. Thus, two sets of alignment features are provided, namely: (1) the fit of gussets 116 with respect to cams 110, and (2) the guide pin 112 and receptacle 112a combinations. These are sufficient to guide test head 100 into a position where test-head electrical interface 126 may accurately connect with DUT adapter electrical interface 128.

A circular cable driver 132 with an attached docking handle 135 is also rotatably attached to face plate 106. Docking cable 115 is attached to each of the cams 110, and to cable driver 132. Idler pulleys 137 appropriately direct the path of the cable to and from cable driver 132. Cable driver 132 can be rotated by means of applying force to handle 135. As cable driver 132 rotates it transfers force to cable 115, which in turn causes cams 110 to rotate in synchronism. Other means of operating the cams are also known. These include, for example, powered actuators as described in U.S. Pat. Nos. 7,109,733 and 7,466,122 and/or solid links as described in WIPO publication No. WO 2010/009013A2, all assigned to in TEST Corporation.

As previously mentioned, extending from the circular-arc cutout 117 of each gusset 116 is a cam follower 110a. Each cam follower 110a fits into the upper cutout 125 on the upper face of its respective cam 110. As cams 110 are rotated, cam followers 110 follow their respective helical groves 129, thus urging test head 100 into its docked position. Docking apparatus using linear cams is also known. Examples include docks manufactured by Reid Ashman, Inc. Also linear cams are described in U.S. Pat. No. 6,407,541 to Credence Systems Corporation as well as in U.S. Pat. Nos. 7,235,964 and 7,276,895 to in TEST Corporation.

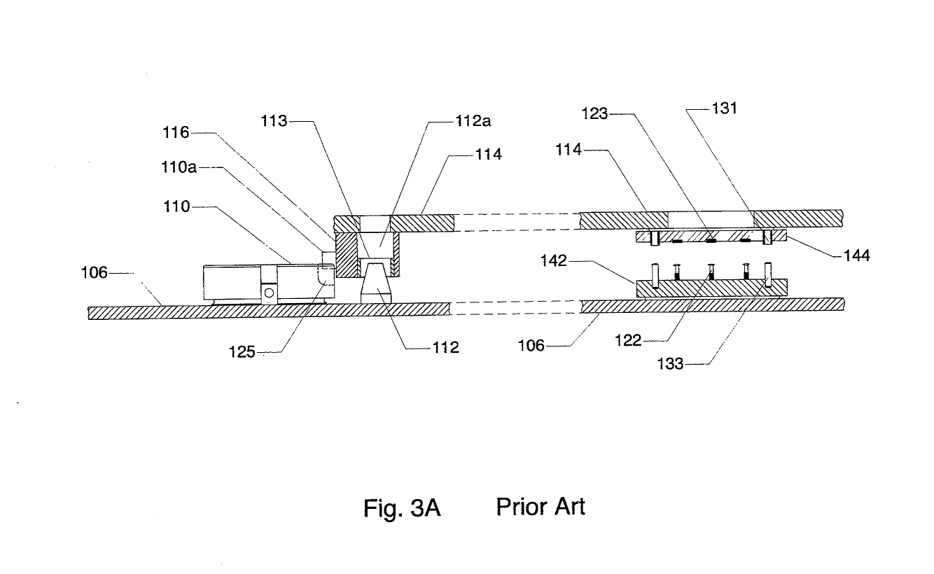

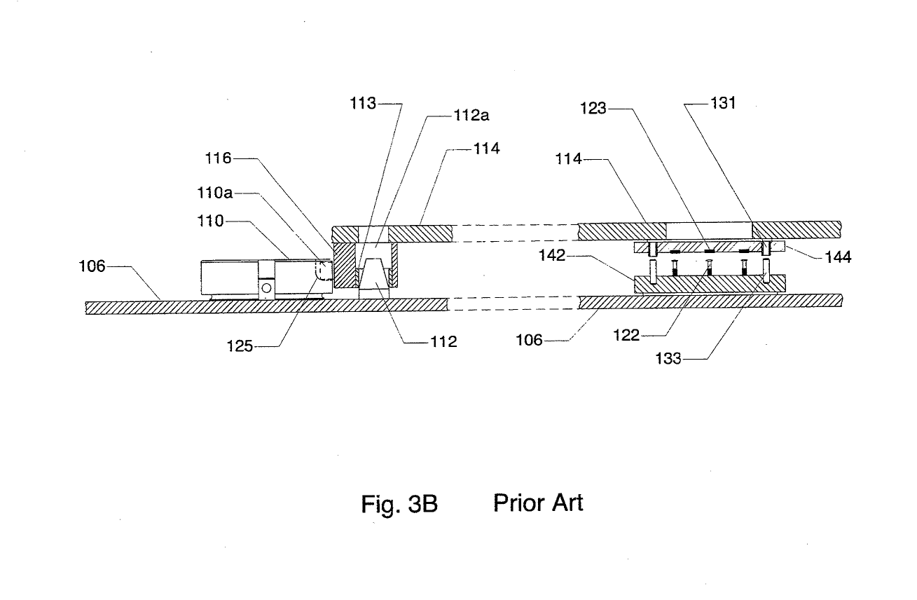

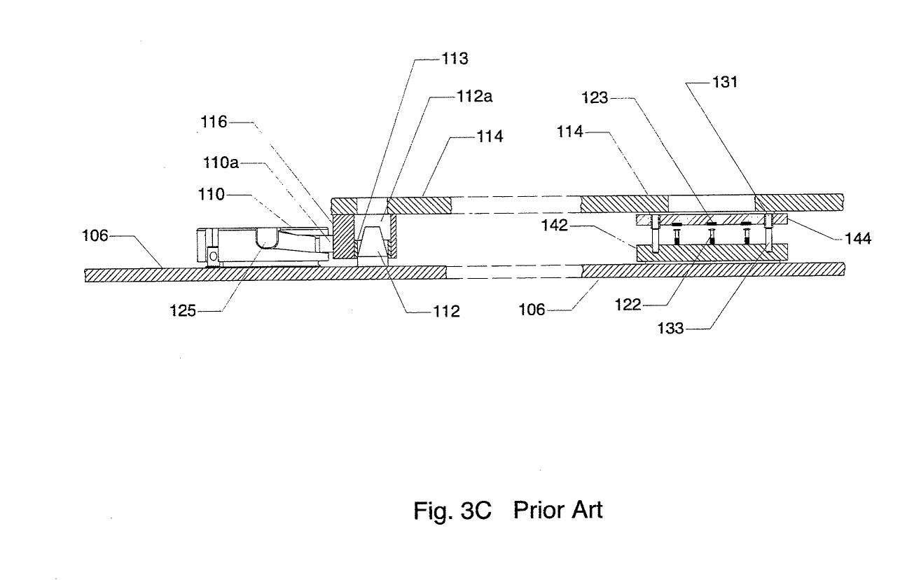

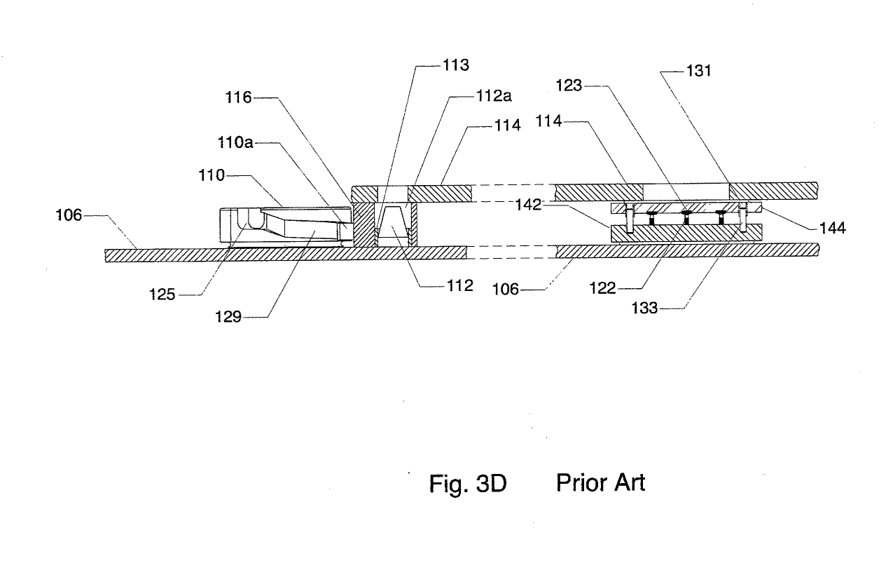

The overall docking sequence will be described with reference to FIGS. 3A-3D. These figures show side views of cam 110 and guide pin 112 mounted on a cross-section of face plate 106. It is cautioned that these figures are not necessarily drawn to scale. A cross-section of gusset 116 attached to gusset plate 114 is also shown. The cross-section of gusset 116 is indicated by W-W in FIG. 2A. Also shown to the same relative scale, but schematically, are DUT adapter 144, signal contact ring 142, signal contact pogo pins 122, DUT adapter landing pads 123, and reference features 131 and 133. FIG. 3A shows in cross-section one stage in the process of docking test head 100 with handler apparatus 108. Here guide pin 112 is partially inserted into guide-pin receptacle 112a in gusset 116. Also cam follower 110a is partially inserted into cam cutout 125. It is noted that in this exemplary case, guide pins 112 are tapered near their distal ends and are of constant diameter nearer to their point of attachment to face plate 106.

In FIG. 36, guide pin 112 has been inserted into guide-pin receptacle 112a to a point where the region of constant diameter is close to entering the guide-pin receptacle 112a, preferably within a few hundredths of an inch of entering the guide-pin hole 112a. Also in FIG. 3B, cam followers 110a have been fully inserted into upper cutouts 125 on the upper faces of their respective cams 110 to a depth where it is at and touching the uppermost end of the helical cam groove 129. As all components have been manufactured and assembled to close tolerances, this establishes approximate parallelism or planarity between the planes of the two interfaces 126 and 128. In this configuration, the dock is ready to be actuated by applying force to the handle 135 (not shown in FIGS. 3A-3D) and rotating the cams 110. Accordingly, the configuration shown in FIG. 3B may be referred to as the “ready to actuate” position. It is important to note that in this position, alignment in five degrees of freedom has been approximately achieved. In particular, if the plane of the DUT adapter electrical interface 126 is the X-Y plane of the three-dimensional interface, guide pins 112 having close to their full diameter inserted into receptacles 112a has established approximate X, Y, and theta Z alignment. Furthermore, the full insertion of cam followers 110a fully into all cut outs 125 has established planarization between the handler apparatus electrical interface 126 and the test head electrical interface 128 to within a small fraction of one degree. At this stage of docking, reference features 131 and 133 are not yet engaged, and electrical interfaces 126 and 128 are still separated.

In FIG. 3C cam 110 has been partially rotated, causing face plate 106 to be moved closer to gusset 116 and gusset plate 114. In the course of this motion the full diameters of guide pins 112 have entered their respective guide-pin receptacles 112a, improving X, Y, and theta Z alignment to within a few thousandths of an inch. This action was followed by reference pins 133 coming into proximity to and then initial engagement with reference features 131. In the position shown reference pins 133 and features 131 are in initial engagement. Because the error and repeatability of the alignment provided by guide pins 112 and guide pin receptacles 112a is plus or minus a few thousandths of an inch, it is preferable that the reference features include a “lead-in” region, such as tapering at a distal end, to facilitate their initial engagement.

FIG. 3D shows the result of fully rotating cams 110. Test head 100 is now “fully docked” with handler apparatus 108. In this position the individual electrical contacts 122 (e.g. pogo pins) of test-head electrical interface 126 are fully conjoined with their corresponding and respective electrical contacts 123 (e.g. landing pads) of DUT adapter interface 128. Thus, electrical conductivity is desirably established between respective contacts 122, 123. It is seen that fully rotating cams 110 in synchronism has caused cam followers 110a to follow the helical grooves 129 to a point in closer proximity to faceplate 106. In addition, guide pins 112 are fully inserted into their respective guide-pin receptacles 112a; and reference features 131 and 130 are fully engaged with one another. Also in the docked position, planar surfaces 118 of gussets 116 bear against landing areas 116a of face plate 106 and thus determine the final docked distance and docked planarization between the docked entities. Reasonably precise machining and assembly enable the spacing and planarity between the docked gusset plate and face plate to be controlled to within plus or minus a few thousandths of an inch. Because the mating electrical contacts are usually designed to have a range of compliance in the Z direction, this relatively small variation is generally not problematical. Furthermore, the spacing between adjacent gussets may typically be in the range of 15 to 20 inches; and this infers a planarization accuracy and/or repeatability on the order of plus or minus one second of one degree. This small degree of possible tilt of one interface plane relative to the other does not result in any significant degree of error in the relative X, Y, Theta Z placement of their respective electrical contacts.

The accuracy and repeatability of positioning the contacts with respect to one another is therefore mainly a function of accuracy and repeatability in the X-Y plane. It is observed that the closeness of the fit of reference features 131 and 133 in conjunction with the fit between guide pins 112 and guide-pin receptacles 112a determines the final alignment between the handler electrical interface 128 and the test head electrical interface 126. The respective fits of these features should be such that they may engage and disengage without undue force or binding. Also, it is preferable to avoid interference between the sets of features as they sequentially become engaged and disengaged. For example, there should preferably be enough looseness of fit between guide pins 112 and guide-pin receptacles 112a so that the engagement of reference features 131 and 133 does not cause binding of guide pins 112 within guide-pin receptacles 112a. Accordingly guide pins 112 must be precisely placed on face plate 106 with respect to both the reference features 133 and gussets 116. To facilitate this, guide pins 112 may be attached in a manner that allows their position to be adjusted. A manner of doing this which is widely practiced is described in the '815 patent. To aid in this calibration procedure, a calibration fixture having features to engage reference features 133 as well as through-bores sized to receive guide pins 112 and that are spaced apart according to the gusset 116 layout may be employed. Such techniques are well known in the art. Overall, a docking accuracy and repeatability with respect to the X-Y plane in the range of a few thousandths of an inch is typically achievable. That is to say, a few thousandths of an inch of “slop” is present in the system. It is to be noted that once guide pins 112 have been calibrated into a proper position, the use of reference features 131 and 133 may not be necessary in docking. This depends in part on the nature of the fit between reference features 131 and 133, and the situation has led some users in certain applications to not utilize these features in docking. Thus, for purposes of this specification they may be considered as optional.

In summary, an initial coarse alignment between gussets 116 and cams 110 to within a fraction of an inch is sufficient to enable the tapered ends of guide pins 112 to engage respective receptacles 112a and to allow cam followers 110a to enter cam cutouts 125. Rotation of cams 110 causes the full diameter of guide pins 112 to interact with receptacles 112a, controlling three degrees of freedom with respect to the X-Y plane, while the cam slots 127 interacting with cam followers 110s control the remaining three degrees of freedom, namely, height and planarity (pitch and roll). In the final docked position, alignment of these height and planarization degrees of freedom has been transferred to and controlled by gussets 116. Accuracy and repeatability with respect to height and planarity are acceptable for present and perceived future applications. However, as previously discussed, accuracy and repeatability in X, Y, and Theta Z of a few thousandths of an inch is considered by many to be problematical for state-of-the-art and future applications.

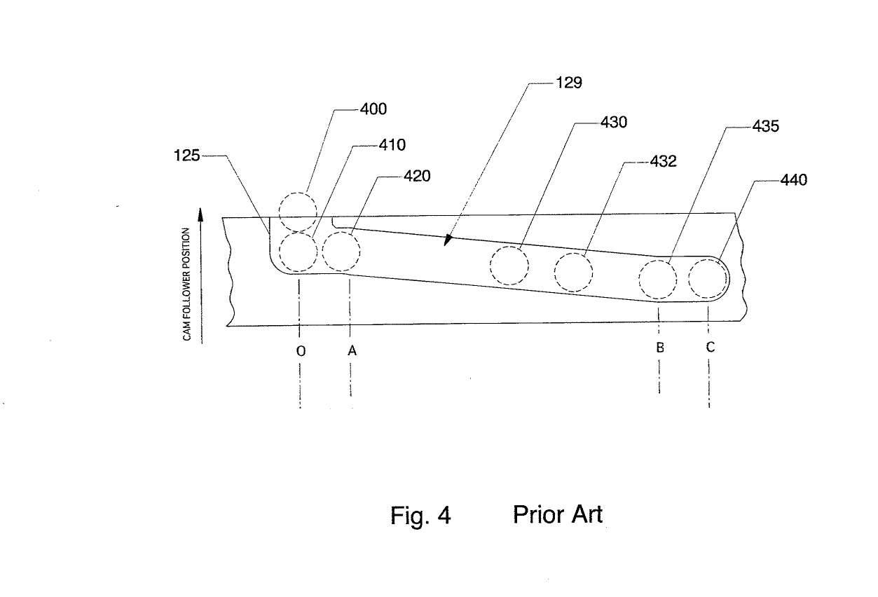

Before proceeding to describe embodiments of the invention, it is useful to review some information about the movement of the cam followers. FIG. 4 illustrates the vertical position of cam follower 110a at various points of cam 110 motion. FIG. 4 applies to circular (or cylindrical) cams as well as to linear cams as used in certain alternative docking apparatus as previously described. The shapes of the cam groove 129 and cut out 125 are schematically shown in FIG. 4, which is not drawn to scale as its purpose is illustrative. The cut out area where the cam follower 110a can enter or exit the cam groove is indicated at point O. The cam follower 110a (illustrated as a dotted circle at various points in cam groove 129) enters the cut out 125 at position 400, and subsequently reaches position 410 corresponding to a “ready to actuate” position. The cut out area 125 is connected to a generally horizontal region of groove 129 between points O and A. This horizontal region is generally one to two cam follower 110a diameters in length (but may sometimes be less) and represents only a small portion (a few degrees) of the total cam motion. Once cam follower 110a has been inserted to the bottom of the cut out 125, cam 110 may be rotated to “capture” cam follower 110a in this horizontal region. Thus, cam follower 110a is “captured” at position 420. At point A, the horizontal groove transitions to a sloping groove as cam 110 is moved further. As cam 110 is moved, cam follower 110a is accordingly raised or lowered vertically. At point B at the lower end of the slope, the groove transitions to a generally horizontal region that is typically at least one or two cam follower diameters long. In this latter region, cam follower 110a is at the extent of its travel, and the apparatus is fully docked. The apparatus is considered to be latched (or alternatively fully docked and locked) when cam follower 110a is at point C (illustrated with cam follower 110a at position 440), the furthest extent of the groove. The region from A to B may be referred to as the “midway” region (illustrated with cam follower 110a at position 430), and the region from B to C may be referred to as the docked region.

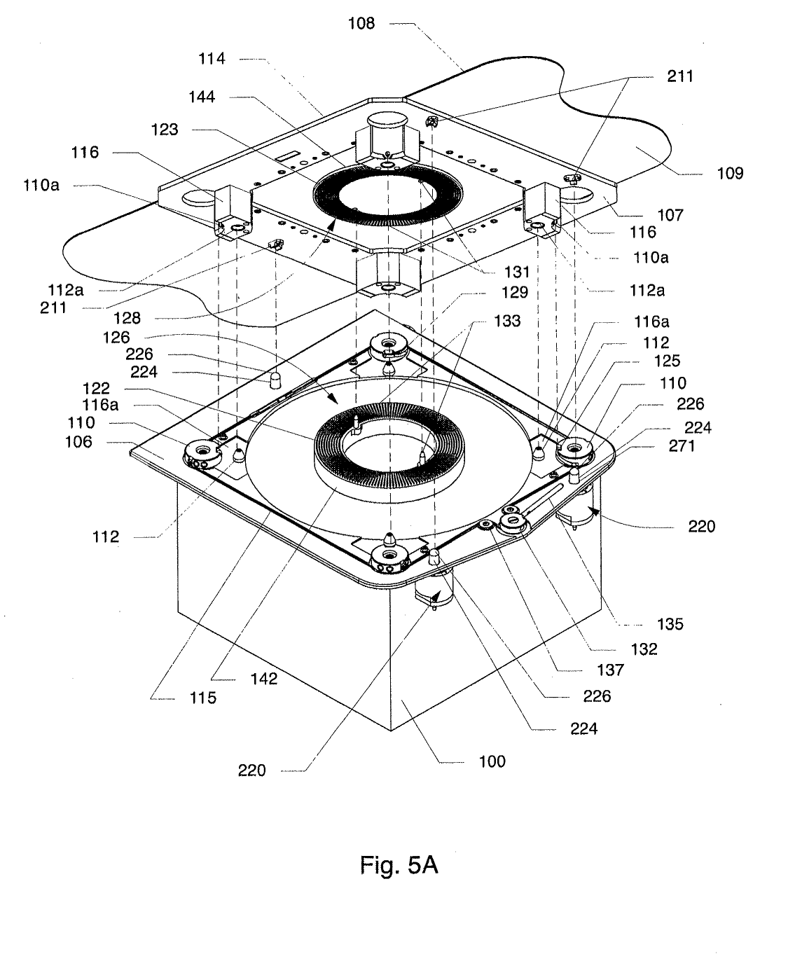

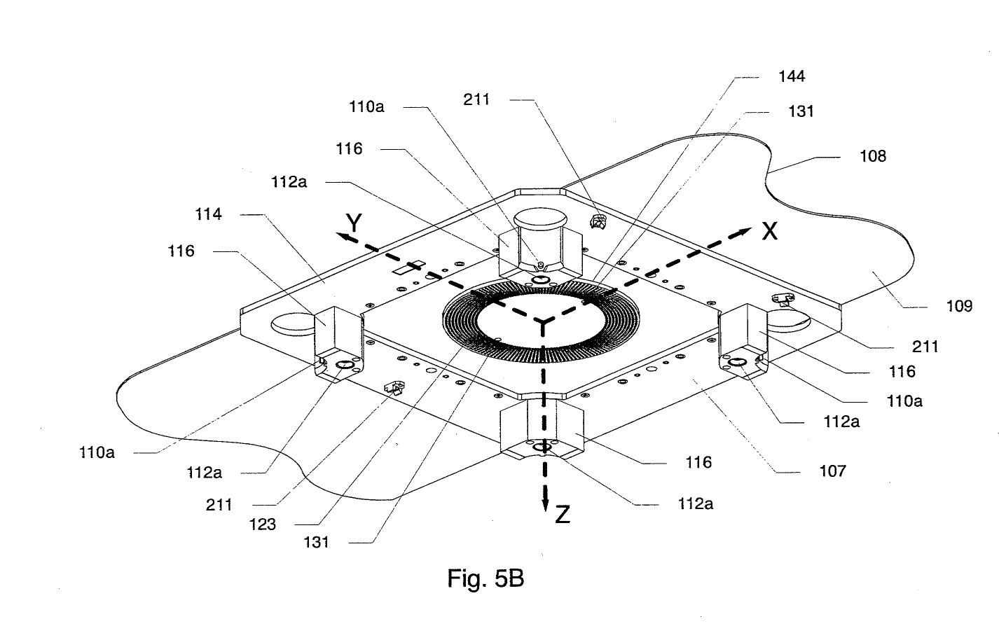

With reference to FIGS. 5A through 8H, a first exemplary embodiment of the present invention will now be described. The objective of the invention is to provide methods and apparatus for improving docking repeatability and accuracy with respect to the docking plane by approximately an order of magnitude or better. In brief, exact-constraint/kinematic features, which constrain position and motion through positive contact, are incorporated to establish precise accuracy and repeatability in the docking plane while existing, prior-art features such as gussets and cam mechanisms are retained for establishing docked distance and docked planarity. Although the first embodiment to be described incorporates ball and groove features, the invention is not limited to ball and groove features; other feature types from the field of precision mechanics, including other exact-constraint/kinematic features, may also be adapted as will be later suggested. The features that are provided to achieve these ends will be referred to as “position-constraining” features.

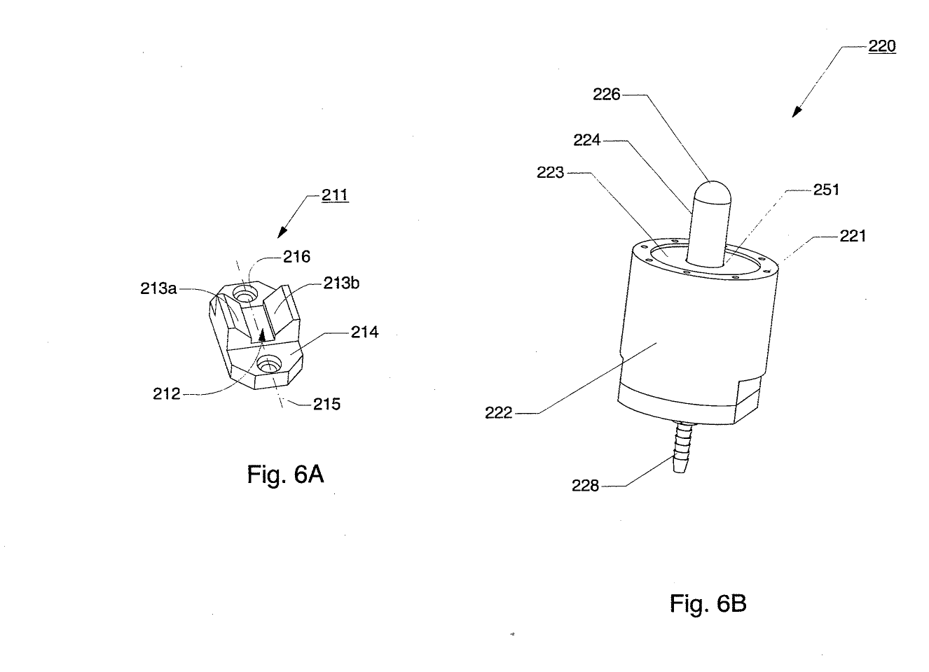

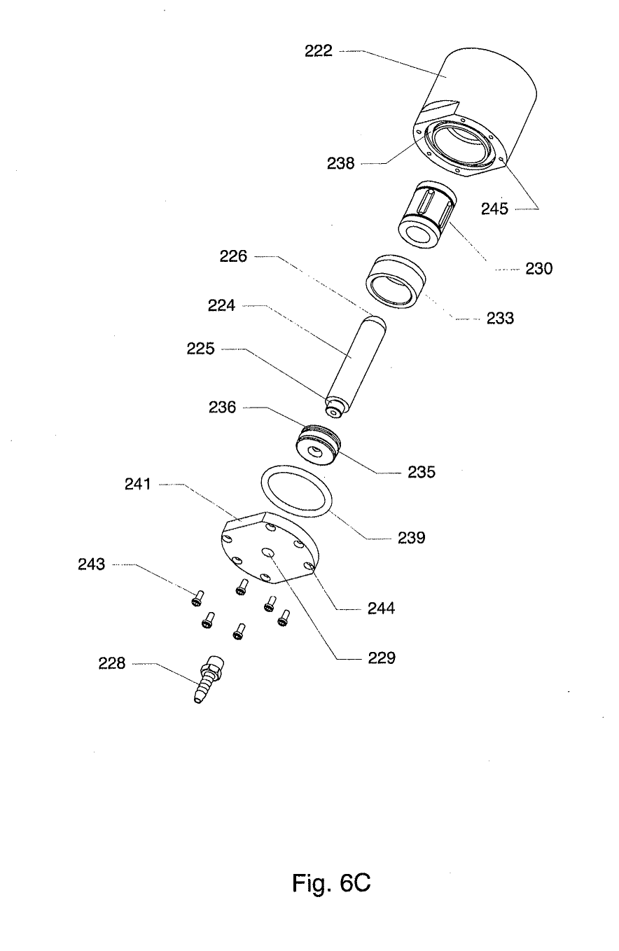

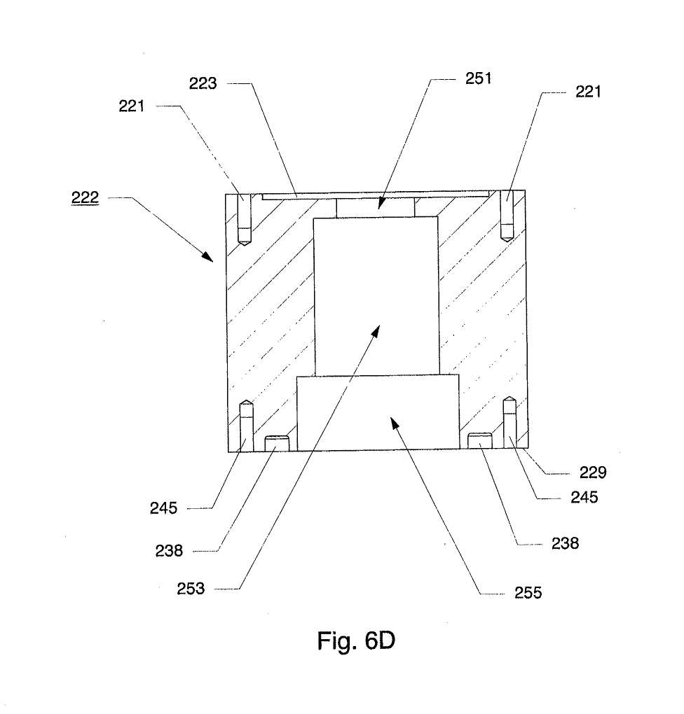

FIG. 5A illustrates a first exemplary apparatus incorporating position-constraining features in accordance with the invention. It is similar to the previously described prior art apparatus of FIG. 1A, and is a peripheral-mounted-DUT-adapter system. However, the system has been improved with the addition of position-constraining features including three Vee-groove blocks 211 attached to gusset plate 114 and three corresponding compliant feature units 220 (two are visible and one is mostly obscured from view) attached to test head face plate 106. Vee-groove blocks 211 are shown more clearly in FIG. 6A, and they include cut-out region 212 that has two opposed, outwardly-sloping sides 213a,b, forming a truncated Vee-shaped groove. In the illustrated exemplary embodiment, sides 213a,b slope at a 45 degree angle with respect to base portion 214; however, other angles could be utilized if desired. Sloping sides 213a,b are spaced to receive spherically-shaped distal end 226 of shaft 224 that is included in compliant feature unit 220 shown in FIG. 6B (to be described later), thus forming two points of contact.

As described in the literature of exact-constraint/kinematic couplings, including various previously mentioned publications and patent documents, the sloping sides 213a,b may be replaced by other shapes, such as a gothic arch, to provide two points of contact with an engaging spheroidal surface. An orientation axis 215 may be associated with each groove block 211. Orientation axis 215 is parallel to and coincident with the upper surface of base region 214 and is also parallel to and midway between sloping sides 213a,b. Preferably groove blocks 211 are arranged on gusset plate 114 such that their three respective orientation axes 215 intersect at or near the center of peripheral-side electrical interface 128. It is also desirable that the three groove blocks 211 are located at the corners of a triangle that is as close as reasonably possible to an equilateral triangle. Base portion 214 includes counter-bored screw holes 216; screws passing through holes 216 and threaded into gusset plate 114 may be used for securing blocks 211. If holes 216 are made somewhat oversized relative to the screws, the positions of blocks 211 may be adjusted as need be.

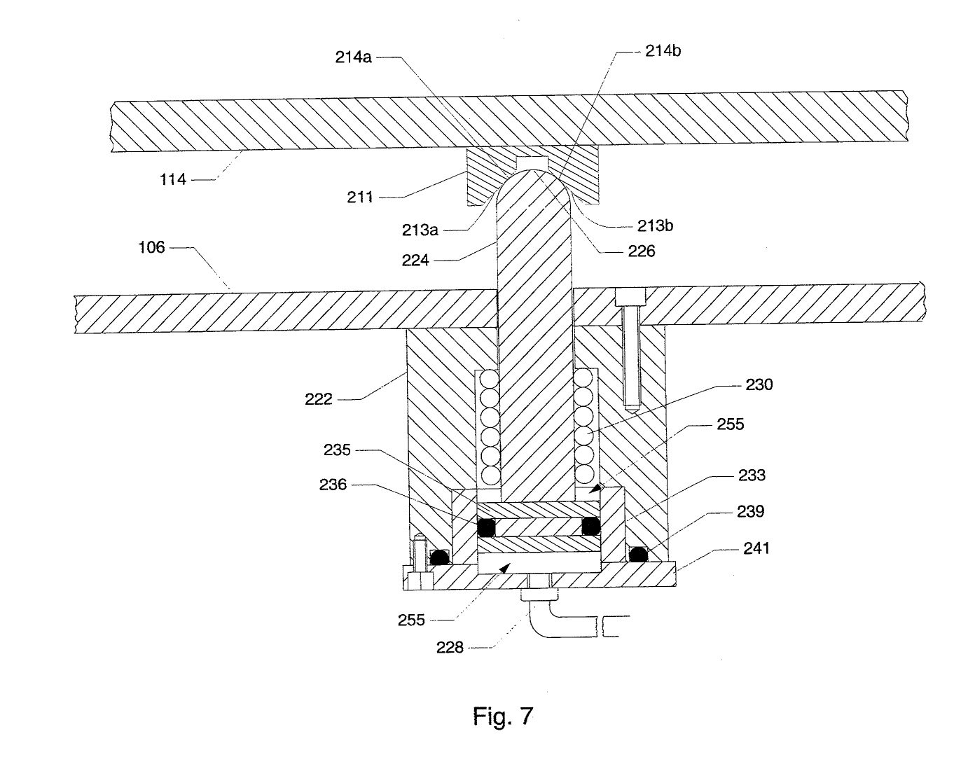

An exemplary compliant feature unit 220 is shown in assembled and exploded perspective views in FIGS. 6B and 6C, respectively. Housing 222 is preferably made of aluminum or other metallic material but other materials may be utilized. Housing 222 is shown as being essentially cylindrically shaped; however, other shapes may be utilized. Housing 222 includes first end region 223 and second end region 229. First end region 223 of housing 222 includes threaded holes 221 configured to receive screws (not shown in FIG. 5A) for attachment to face plate 106. FIG. 6D provides a cross-section view of housing 222, which defines three concentric, cylindrically-shaped holes 251, 253 and 255 that are arranged end to end, providing a through passage. FIG. 7, to be discussed in more detail later, includes a cross-section view of an assembled compliant feature unit 220. Hole 255 receives and retains bushing 233 and is sized accordingly for a press fit. Hole 253 receives and retains linear bearing 230 and is also sized accordingly for a press fit. An exemplary linear bearing 230 is a Thomson Precision Steel Ball Bushing Bearing; also the aforementioned '944 patent describes possible alternatives. The diameter of shaft 224 is sized to provide a sliding fit within linear bearing 230. Hole 251, which penetrates end region 223 is slightly larger than the diameter of shaft 224, allowing shaft 224 to freely move therethrough. Thus, shaft 224 is inserted through linear bearing such that its hemispherical end (distal end) 226 penetrates end region 223. Piston 235 is attached to the opposite or interior end 225 of shaft 224, which is machined appropriately to receive it. Piston 235 includes circumferential O-ring 236, and the combination is sized to slidingly fit within bushing 233, with O-ring 236 providing a relatively air-tight seal between the two. End cap 241 is secured to second end region 229 of housing 222 by means of screws 243 which are received by tapped holes 245. To provide an air-tight seal between the two, O-ring 239, which fits within groove 238 on second end region 229, is provided therebetween. Thus a cylindrical cavity is formed within bushing 233 between piston 235 and end cap 241. This cavity may be filled with fluid supplied through inlet device 228, thus providing a pressurizable fluidic cylinder/piston combination to control force applied by and the motion of shaft 224. In an exemplary embodiment, the fluid is air at a controlled pressure. However, according to needs and circumstances other fluids may be used including, for example, other gases or hydraulic liquids.

Compliant feature units 220 are attached to face plate 106 so that their housings 222 are located on the side of face plate 106 that faces away from the peripheral 108 and so that the distal portions of shafts 124 extend through face-plate holes 271 and point in the direction of the peripheral 108. Compliant feature units 220 are attached to face plate 106 with appropriate screws (not illustrated) that extend through appropriate holes in face plate 106 and which are received by threaded holes 221 in the periphery of first end region 223 of housing 222. Further, compliant feature units 220 are disposed on face plate 106 so that, when test head 100 is docked to peripheral apparatus 108 in a desired position, spherical ends 126 of shafts 124 contact the sloping sides 213a,b of groove blocks 211 in the manner of a kinematic ball-and-groove coupling.

FIG. 7 provides a cross-section view of compliant feature unit 220 attached to face plate 106 contacting groove block 211, which is attached to gusset plate 114. It is seen that sloping side 213a contacts spherical end 226 at a single point 214a and that sloping side 213b contacts spherical end 226 at point 214b. Fluid pressure applied to pistons 235 provides preload force to securely engage the spherical features 226 with their respective groove sides 213a,b. This is illustrated in FIG. 7 where fluid pressure has driven piston 133 to a midway position within bearing 230, driving spherical shaft end 226 into contact with groove block 211. This arrangement provides very precise, highly repeatable, position-constraining docking-plane alignment of test head 100 with peripheral apparatus 108. The screw body holes used for mounting either or both groove blocks 211 and compliant feature units 220 may be appropriately oversized so that the positions of either or both may be fine tuned to adjust or calibrate the docked position of test head 100 to a desired location with respect to the three degrees of freedom in the docking plane. Due to the moveability or compliance of shafts 224 in the Z direction, calibration adjustments with respect to the remaining three degrees of freedom are advantageously not necessary and do not need to be accounted for with any extra mechanisms. Instead gussets 116, cams 110, and cam followers 110a may be used as in the prior art to control these remaining degrees of freedom. Once calibrated, test head 100 may be repeatedly docked to the desired peripheral with a repeatability of significantly less than one one-thousandths of an inch.

To work effectively, however, the axes of shafts 224 must be approximately pre-aligned so as to approximately orthogonally intersect the orientation axes 215 of their respective groove blocks 211 before spherical ends 226 are brought into actual physical contact with groove sides 213a,b. Preferably, such pre-alignment should be to within a few thousandths of an inch to ensure smooth operation and to prevent undue wear to the components by allowing them to scrape against one another. By applying existing, prior art docking techniques, this goal may be readily achieved.

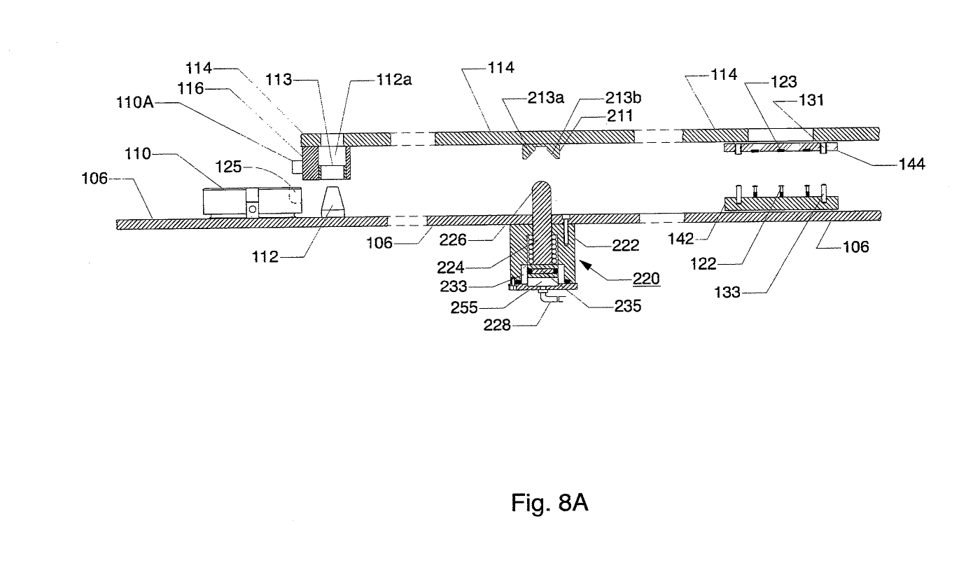

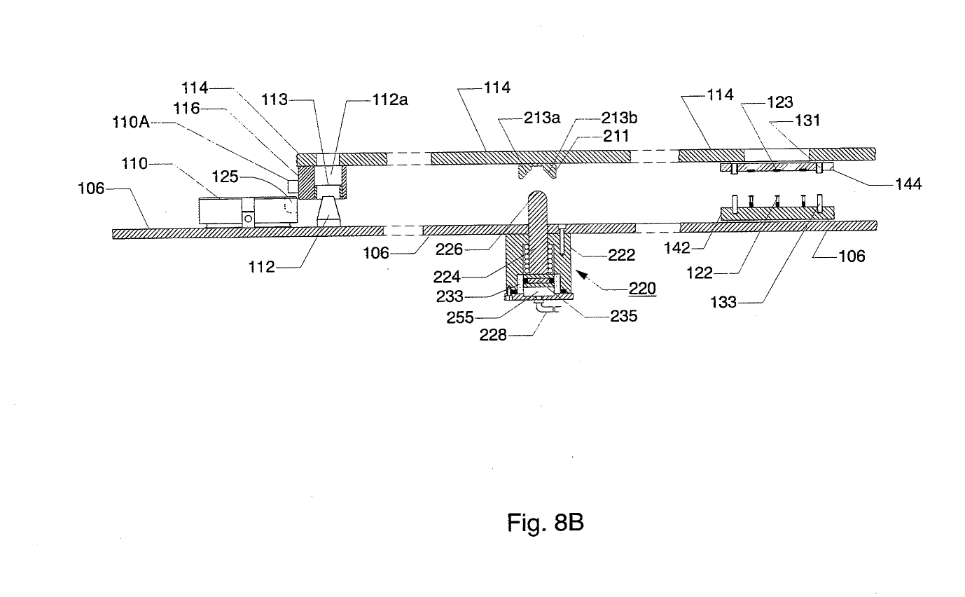

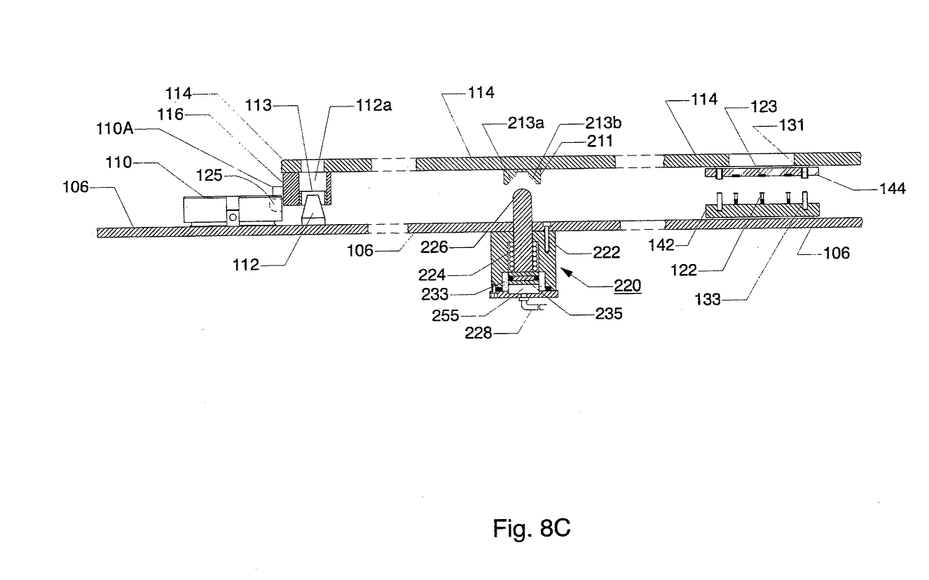

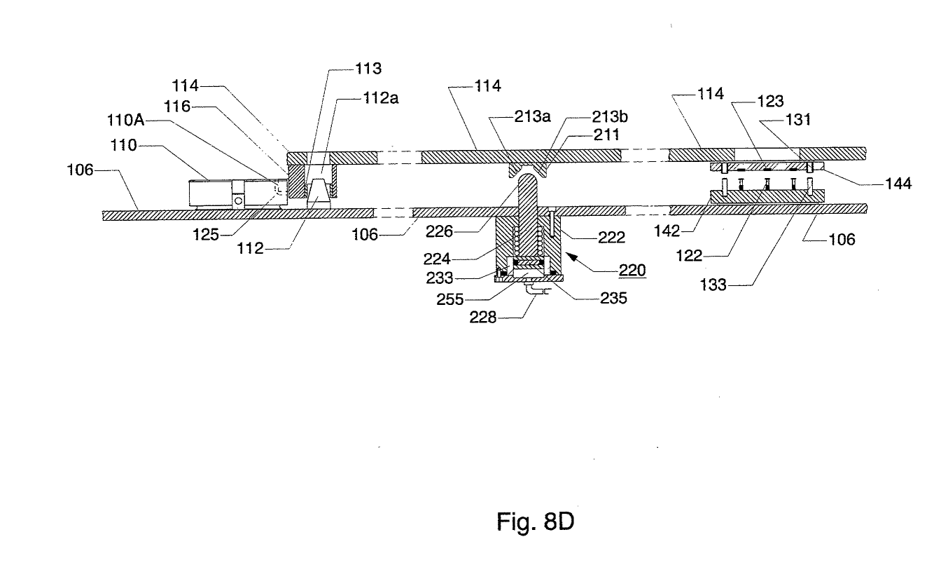

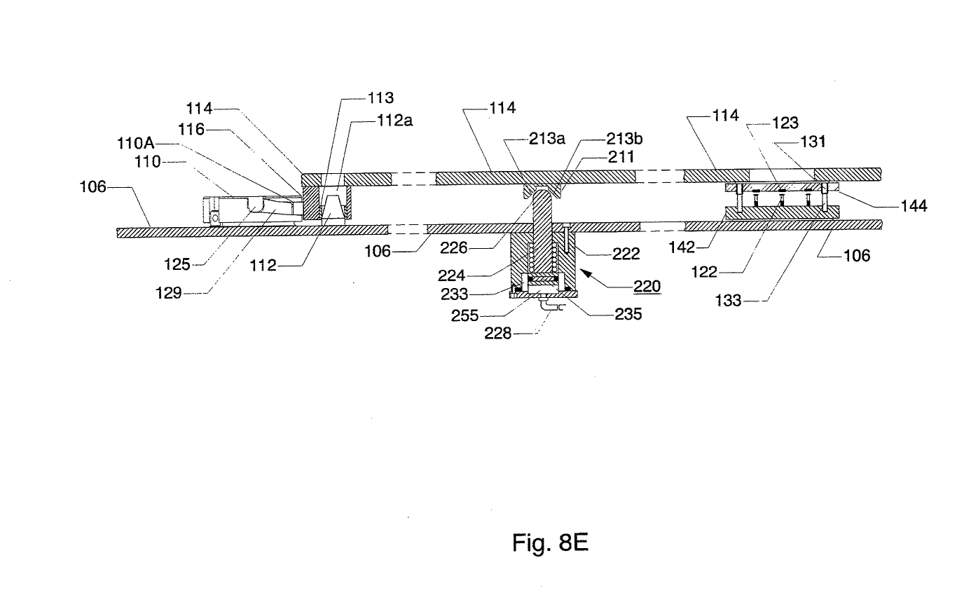

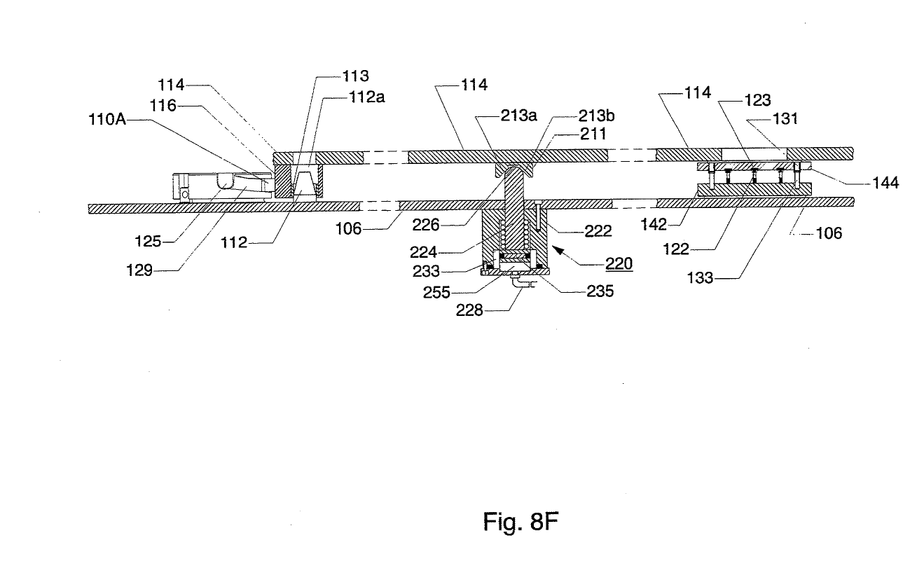

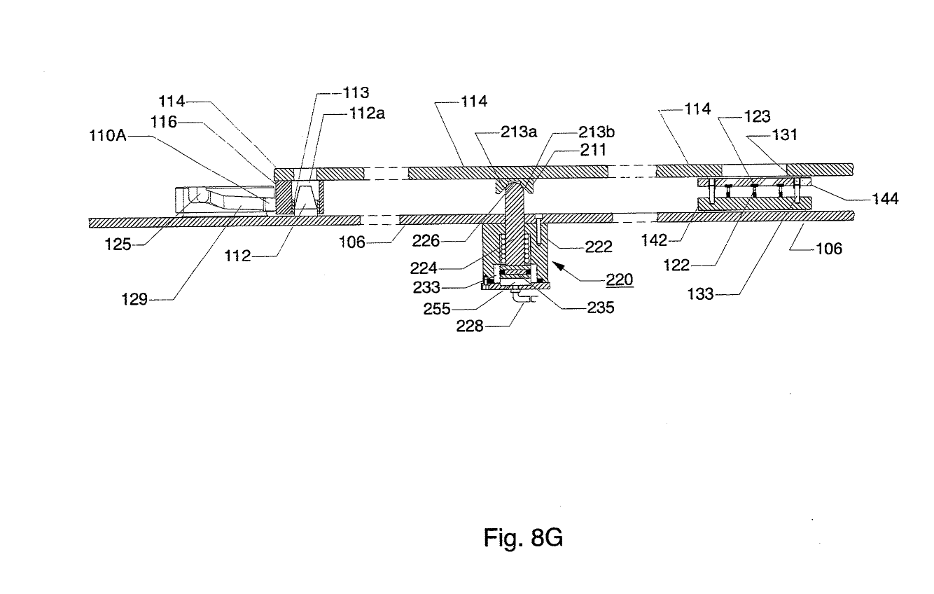

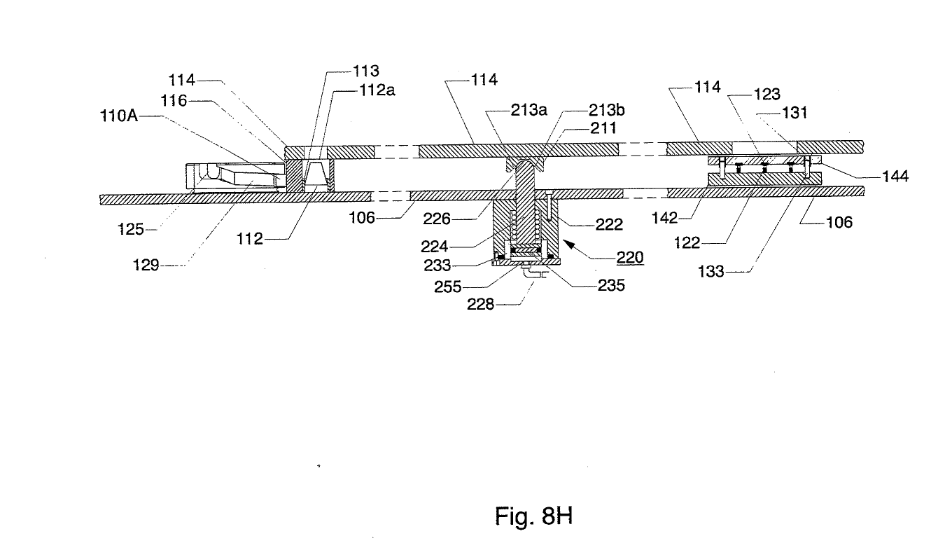

The overall docking sequence will be described with reference to FIGS. 8A through 8H. As was the case in FIGS. 3A through 3D, these figures show side views of cam 110 and guide pin 112 mounted on a cross-section of face plate 106. A cross-section of gusset 116 attached to a cross-section of gusset plate 114 is also shown. The cross-section of gusset 116 is indicted by W-W in FIG. 2A. Also shown to the same relative scale, but schematically, are interface board 144, signal contact ring 142, signal contact pins 122 (which in this exemplary embodiment are pogo pins), landing pads 123, and optional reference features 131 and 133. Also shown in this series of figures are cross-sections of a compliant feature unit 220 mounted to face plate 106 and its respective groove block 211 mounted on gusset plate 114. Again, it is cautioned that these figures are not necessarily drawn to scale.

FIG. 8A shows the apparatus in a “ready to dock” position where test head 100 has been brought into approximate alignment with handler apparatus 108. In this initial position, none of the alignment features are engaged. It is understood that fluid pressure has been applied to inlet 228 of compliant feature unit 220 driving piston 235 to a position at the end of bushing 233 and hole 255 that is closest to face plate 106, thus causing shaft 224 to be in an extended position.

FIG. 8B shows a next stage of docking. Here the top of cam 110 is just overlapping the bottom of gusset 116, providing coarse alignment to within approximately ⅛ to ¼ inch or less in the X-Y plane. Further the tip of guide pin 112 has just entered its respective guide-pin receptacle 112a. None of the other alignment or precision features have come into play.

FIG. 8C shows the next stage in the process of docking test head 100 with handler apparatus 108. This stage corresponds to that of FIG. 3A in the previous discussion of an embodiment of the prior art. Here guide pin 112 is partially inserted into guide-pin receptacle 112a in gusset 116. Also cam follower 110a is partially inserted into cam cutout 125. It is noted that in this exemplary case, as in FIG. 3A, guide pins 112 are tapered near their distal ends and are of constant diameter nearer to their point of attachment to face plate 106.

FIG. 8D shows the next stage in the process of docking test head 100 with handler apparatus 108, which is the “ready-to-actuate stage.” This stage corresponds to that of FIG. 3B in the previous discussion of an embodiment of the prior art, and the details of that description will not be repeated here. It is noted that at this stage of docking, the distal end 226 of shaft 224 is not in contact with groove block 211, reference features 131 and 133 are not yet engaged, and electrical contacts 122 and 123 are still separated.

In FIG. 8E, which shows the next stage of docking, cam 110 has been partially rotated, causing face plate 106 to be moved closer to gusset 116 and gusset plate 114. This position corresponds to that of FIG. 3C in the earlier discussion of an embodiment of the prior art. In summary of the discussion pertaining to FIG. 3C, cam 110 has been partially rotated pulling test head 100 closer to peripheral 108, cam follower 110A is in a midway position in cam slot 129, and reference features 131 and 133 are in initial engagement. Furthermore, the full diameter of guide pin 112 has just entered guide-pin receptacle 112a. The test head is now positioned to within a few thousandths of an inch with respect to the X-Y plane. Additionally, the distal end of compliant shaft 224 has entered the space between sloping sides 213a,b of groove block 211; however, spherical distal end 226 of shaft 224 has not made contact with sloping sides 213a,b. It is noted that the aforementioned preferable condition of pre-alignment between shaft 224 and groove block 211 has been achieved.

The result of further rotating cams 110 is shown in FIG. 8F, which is the next stage of docking. Here, test head 100 has been drawn still closer to peripheral 108, reference features 131 and 133 have become further engaged, and spherical distal end 226 of shaft 224 has just contacted one or both of sloping sides 213a,b of groove block 211. Air pressure has been maintained within bushing 233 throughout all of the steps of this procedure, and thus shaft 224 is urged into positive contact with groove block 211. Importantly, electrical contacts 122 and 123 are still separated.

In FIG. 8G, the next stage of docking, test head 100 has been drawn still closer to peripheral 108 by rotation of cams 110. Electrical signal contact pins (pogo pins) 122 of electrical interface 126 have made initial contact with their respective landing pads 123 of electrical interface 128. During this motion, fluid pressure has been maintained on piston 235, and the resulting force of shaft 224 has caused spherical distal end 226 to come into positive contact and final aligned position with sloping sides 213a,b of groove block 211. Thus, all electrical contacts have come into final alignment with respect to the docking plane before making physical contact with one another. In this position shaft 224 and piston 235 have compliantly moved away from face plate 106, working against the applied fluid pressure. Also, planar surfaces 118 of gussets 116 have not yet contacted their respective landing areas 116a of face plate 106, and planarity between respective interfaces 126 and 128 is provided by the positions of cam followers 110a in their respective cam grooves 129 and the synchronization of rotation of cams 110.

The final docked position, shown in FIG. 8H, is arrived at by further cam rotation. Cam followers 110a have reached the ends of their respective grooves 129, and cams 110 can not be further rotated. In this position, planar surfaces 118 of gussets 116 are bearing on their respective landing areas 116a of face plate 106 thereby establishing final docked planarity and docked distance between test head 100 and peripheral 108. Also signal contact pins 122 have been compressed; their built in resiliency urges them into firm contact with their respective mating contact areas 123. In addition, fluid pressure has firmly held spherical shaft ends 226 in contact with the sloping sides 213a,b of groove blocks 211 during this final motion, maintaining the important precision alignment to less than one one-thousandths of an inch with respect to the X-Y plane. During this motion, piston 235 and shaft 224 have compliantly moved against the fluid pressure still further away from face plate 106.

In the foregoing discussion and figures, it has been presumed that the reference features 131,133 would be engaged prior to engagement of the position-constraining docking features 226, 213a,b. As would be known to those experienced in the art, other embodiments could readily be construed where features 131,133 are designed such that it is preferable that they come into engagement at the same time as or after the engagement of the position-constraining features. In this case the prior alignment of the position-constraining features 226, 213a,b would guide the reference features 131, 133 into engagement. An important aspect of the invention is the engagement of position-constraining features 226, 213a,b to repeatably establish position with respect to the X-Y plane (i.e., docking plane) before the final docked position is achieved. A second important aspect is utilizing one set of features (in the present embodiment, planar surfaces 118 of gussets 116 and gusset landing areas 116a) to govern the docked distance and docked planarity and a second set of features (position-constraining features 226, 213a,b) to govern the docked X, Y, and Theta Z position. Although the present embodiment uses gussets to establish the docked distance and planarity, it is clear that the technique is applicable, with no significant changes, to systems that rely on the interaction of cams and cam followers or other means to determine these conditions.

The foregoing embodiment utilizes a kinematic or position-constraining coupling having three spherical surfaces contacting three grooved features at a total of six points. As mentioned above, other combinations of position-constraining features are also known, some (but certainly not an exhaustive list) are described in U.S. Pat. Nos. 6,729,589 and 5,821,764, 5,678,944 and 6,833,696 as well as in many of the documents listed above. Various combinations of these alternatives could readily be substituted without changing the overall scheme. Also, it is to be noted that such precision coupling schemes are generally intended to control six degrees of freedom in three-dimensional space, whereas the present invention only requires controlling three degrees of freedom in the two-dimensional docking plane, but with a preload force in the third dimension. Accordingly, a wide variety of alternative position-constraining alignment techniques may be applied in the practice of the present invention.

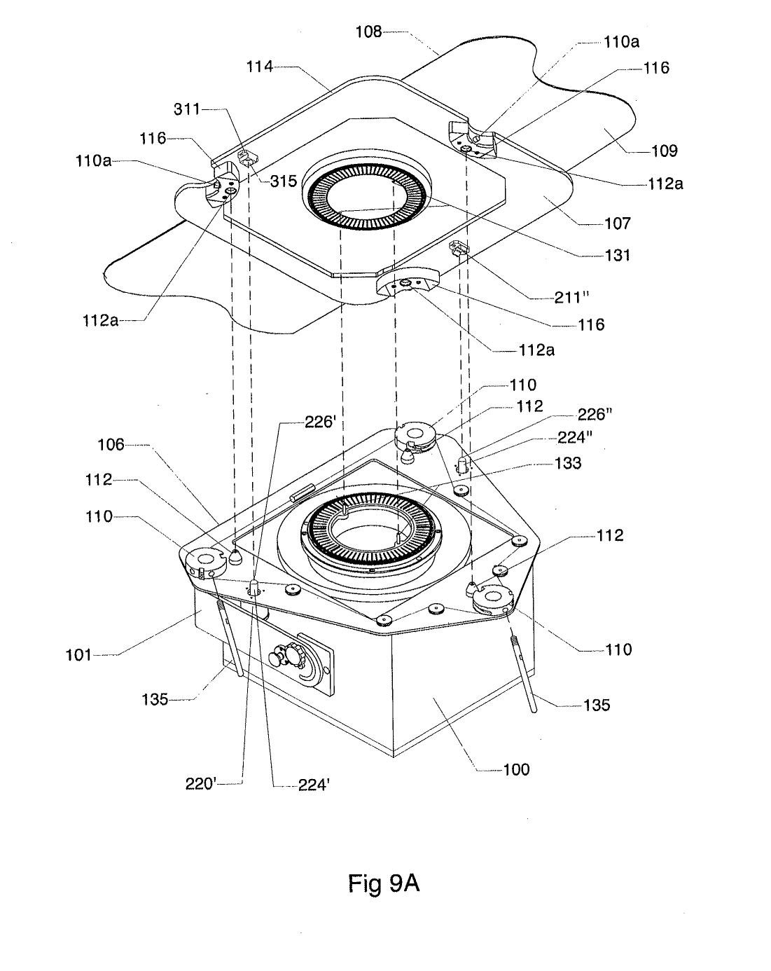

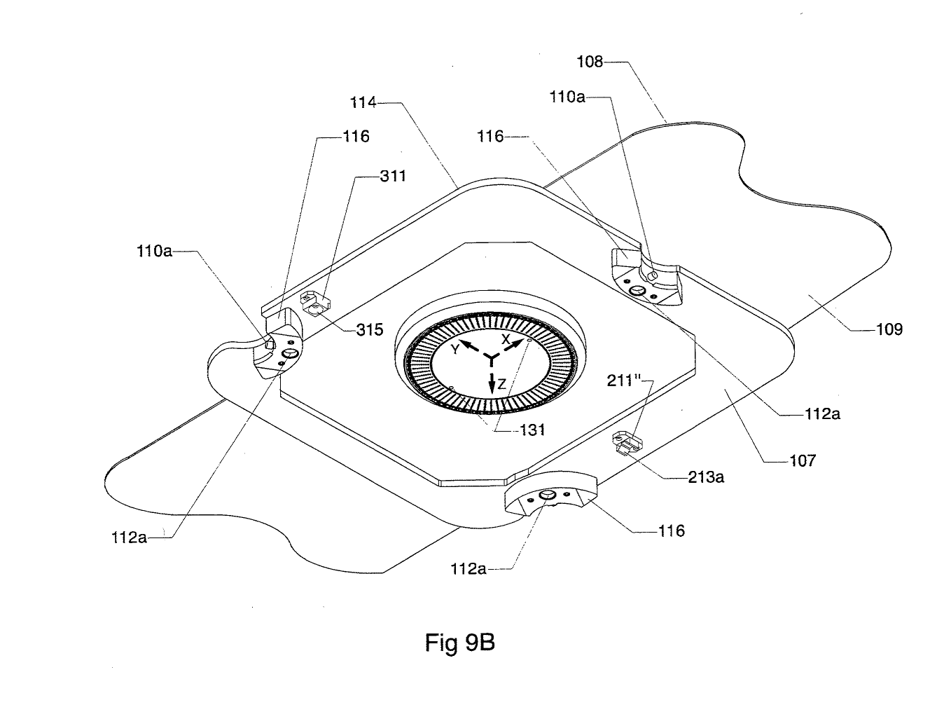

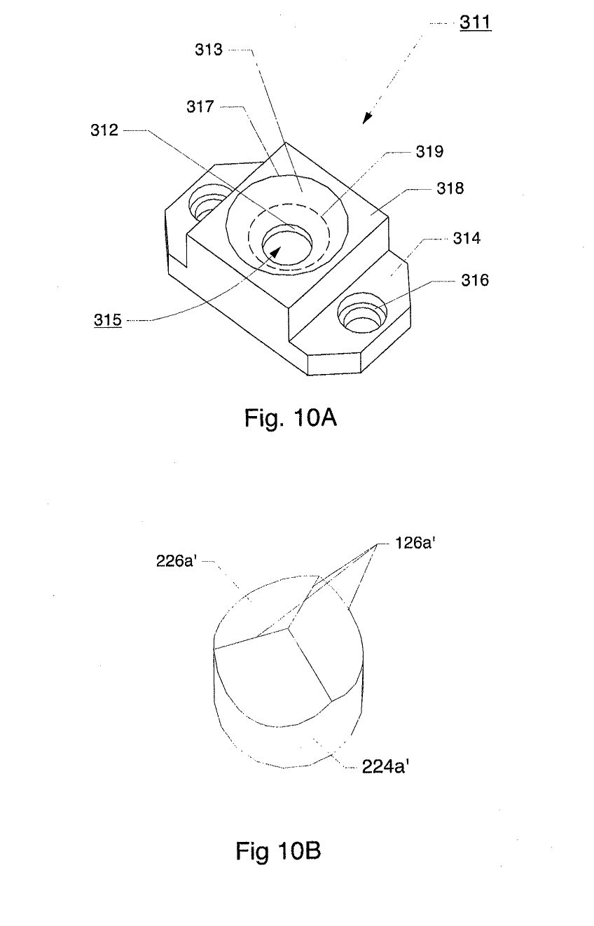

A second embodiment of the present invention incorporating certain alternative position-constraining alignment features will be described with reference to FIGS. 9A-10B. FIG. 9A shows a peripheral-mounted-DUT-adapter system incorporating a second exemplary embodiment of precision alignment features suitable for practicing the invention. Here, test head 100 is shown being held in (not previously shown) cradle apparatus 101. As in FIGS. 1A and 5A, test head 100 is shown below peripheral 108 to which it may be docked with a generally upward motion. FIG. 9B shows a somewhat magnified view of peripheral 108 and the apparatus attached to it. FIGS. 9A and 9B show a docking apparatus having gusset plate 114 attached to outer surface 109 of peripheral 108, face plate 106 attached to test head 100, reference features 131 & 133, three circular cams 110, three gussets 116, three cam followers 110a, three guide pins 112 and three guide pin receptacles 112a. This is known as a “three point dock”; whereas, the apparatus previously described and shown in FIGS. 1A and 5A is known as a “four point dock.” The configuration of FIG. 9A does not use a cable driver as is used in FIGS. 1A and 5A; rather, one or more docking handles 135 (two are arbitrarily shown) are fitted directly to respective circular cams to facilitate actuation. The three-point dock is shown to illustrate one of numerous, known alternatives to the previous four-point dock and to further emphasize that the inventive concepts described herein are independent of the style of the dock and are thus equally applicable to any of these alternatives. The purpose, functionality, operation and interactions of reference features 131 & 133, cams 110, cam followers 110a, gussets 116, guide pins 112, and guide pin receptacles 112a is essentially the same as previously described with respect to FIGS. 1A and 5A and, hence, will not be repeated.

In contrast to the previous discussion, however, the apparatus of FIGS. 9A and 9B includes two compliant feature units 220′ and 220″, rather than three. (The housing of compliant feature unit 220″ is hidden from view.) These are essentially the same as the previously described compliant feature units 220, and they include shafts 224′ and 224″ respectively, each having respective hemispherical distal ends 226′ and 226″, all similar to the previously described shaft 224 and hemispherical end 226. The hemispherical end 226″ of shaft 224″ is received by Vee-block 211″, which is attached to surface 107 of gusset plate 114. Vee-block 211″ is essentially the same as Vee-block 211 described in conjunction with FIG. 5A and FIG. 6A, and the interaction between hemispherical end 226″ and Vee-block 211″ is essentially the same as previously described with respect to FIG. 7. That is, hemispherical end 226″ contacts each side 213a,b of Vee-block 211″ at one point each. The hemispherical end 226′ of the other shaft 224′ is received by an inverse cone-shaped depression 315 in cone block 311, which is also attached to surface 107 of gusset plate 114.

Cone block 311 is shown in larger scale in the perspective view in FIG. 10A. Similar to Vee-block 211, cone block 311 includes counter-bored, mounting-screw holes 316 in base portion 314. Just as with mounting holes 216 in Vee-block 211, mounting holes 316 may be oversized with respect to the mounting screws in order to allow adjustment in the position of block 311 on gusset plate 114. To provide inverse cone-shaped depression 315, a hole 312 with beveled sides 313 is included in the central portion of block 311. This may be formed, for example, by boring a hole in block 311 and then using a countersink tool to form the beveled sides. In the illustrated exemplary embodiment, side 313 is sloped at a 45-degree angle with respect to base portion 314; however, other angles may be used if desired and/or appropriate. The diameter 317 at outer surface 318 is sized so that hemispherical end 226′ of shaft 224′ will penetrate block surface 318. Accordingly, when hemispherical end 226′ is received by cone block 311, hemispherical end 226′ may contact conical depression 313 along a circular line such as dashed line 319 (not necessarily to scale).

The contact between hemispherical end 226′ and cone block 311 establishes the X-Y position of the axis of shaft 224′ with respect to the docking plane, gusset plate 114, and peripheral 108. Further, the interaction of hemispherical end 226″ with Vee-block 211″ establishes the angle between a line in the docking plane connecting the axes of shafts 224′ and 224″ and either the X or Y-axis of the docking plane. In other words, it constrains the test head's Theta Z or rotational degree of freedom with respect to the docking plane. Thus, the interactions between the features constrain all three degrees of freedom (X, Y, and Theta Z) of the test head with respect to the docking plane. It is to be noted that in order to constrain rotation in the plane, orientation axis 215 of Vee-block 211″ should be orientated so that the docking-plane-parallel components of the preload reaction forces at the contacts between sides 213a,b and hemispherical end 226″ generate non-zero, opposing moments about a center of rotation determined by the fit of the other hemispherical end 226′ in its contact with cone-block 311. Such moments would preferably be optimized if orientation axis 215 is arranged so that it intersects the center of rotation. This arrangement (ball-in-a-cup plus ball-in-a-groove) is related to the previously described Kelvin-clamp (reportedly originated by Lord Kelvin) form of exact-constraint or kinematic coupling. However, the Kelvin-clamp's single contact point between a spherical surface and a surface in the plane is neither necessary nor included because the cams 110 and cam followers 110a and/or gussets 116 control the docked planarity and docked distance between the docked elements. The position-constraining features provided are sufficient to control and constrain position and alignment in the three degrees of freedom (X, Y and Theta Z) with respect to the docking plane.

The docking procedure using the apparatus of FIG. 9A is essentially the same as previously described with regards to using the apparatus of FIG. 5A. That is, it is essentially as shown in FIGS. 8A-8H with appropriate substitutions made. In particular, block 211 in FIGS. 8A-8H may represent either Vee-bock 211″ or cone block 311. Similarly, compliant feature unit 220, shaft 224, and spherical end 226 may represent either compliant feature unit 220′ or 220″ and their respective shafts 224′ and 224″ with respective hemispherical ends 226′ and 226″. In terms of docking accuracy and repeatability, the two systems are for all practical purposes equivalent. However, the apparatus of FIG. 9A is less expensive than that of FIG. 5A in that it has just two rather than three compliant feature units. For the same reason, the apparatus of FIG. 9A requires less space, which may also be advantageous. Finally, the apparatus of FIG. 9A may be more straightforward to calibrate in that there are only two feature sets to adjust as compared to three. Also, in the apparatus of FIG. 9A, one of the feature sets controls an X-Y position while the other controls Theta-Z rotation, which may be useful to further simplify the calibration process in comparison to the three interacting feature sets of FIG. 5A.

Those familiar with the field will recognize that the inventive concept is not limited by the feature sets that have been shown and described. Indeed, many alternative feature sets have been shown and discussed in the literature. For example, a straightforward alternative embodiment to the system of FIG. 9A would be one where shaft 224′ is replaced by a shaft 224a′ having a distal end 226a′ formed in the shape of a tetrahedron (i.e., a three sided pyramid) as illustrated in FIG. 10B. The sides of the tetrahedron are formed at an angle such that the three edges 126a′ of the tetrahedron may be received by cone block 311 with essentially three straight lines of contact. This arrangement could be further modified by adding convex curvature to the sides and edges of the pyramid, which would provide three points of contact rather than three lines of contact. Although the repeatability provided by the three alternatives may vary, any of the three techniques described offer greatly improved repeatability in comparison to the prior art and meet the objectives of the present invention. Also companies such as the previously mentioned Ball-tek and g2 engineering provide a variety of hardware components that could be incorporated in the practice of the invention. For example, Ball-tek offers half cylinders (“truncated cylinders”) that may be used in parallel pairs in lieu of a Vee-block. Arrangements using a similar technique are shown, for example, in U.S. Pat. No. 6,833,696 to Xandex, Inc. Also spherical and partial spherical shapes, cone blocks and the like can be purchased commercially. It is conceivable that many of these may be substituted for the features that are explicitly described herein.

The two previous exemplary embodiments of the invention illustrate its application and operation in representative peripheral-mounted-DUT-adapter systems. Test-head-mounted-DUT-adapter systems will next be considered in third and fourth exemplary embodiments.

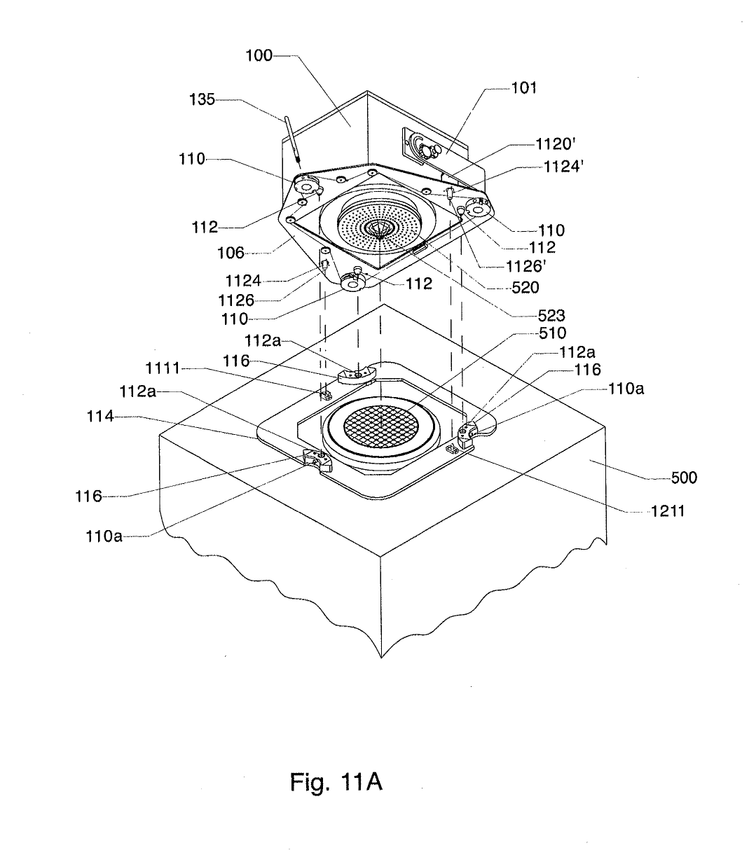

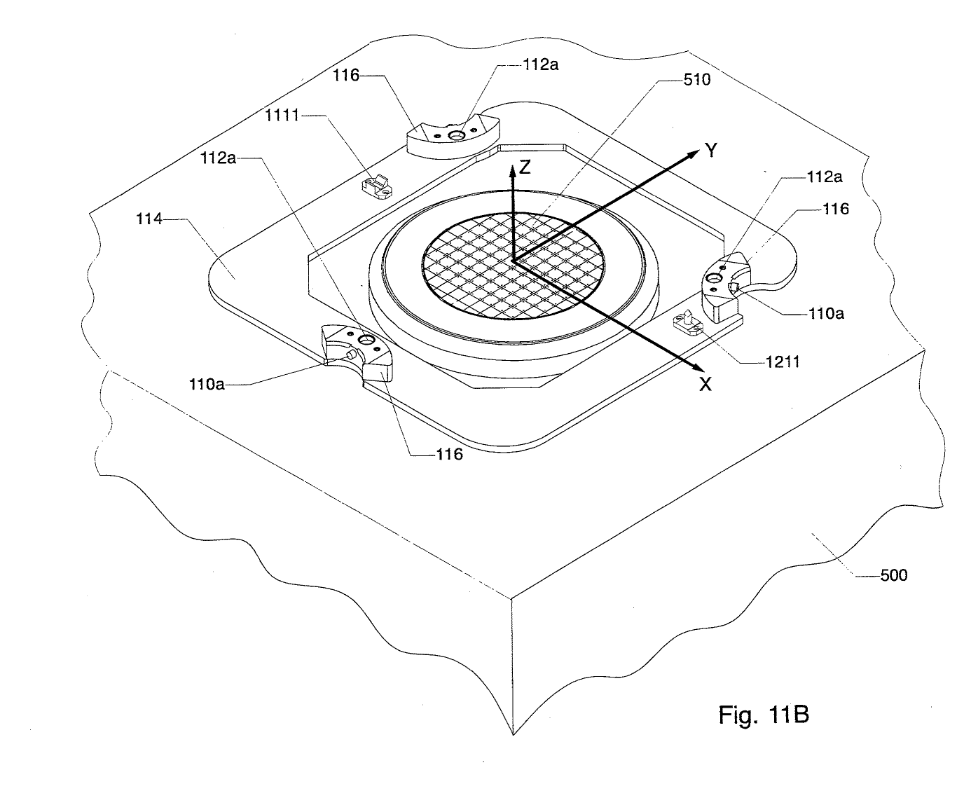

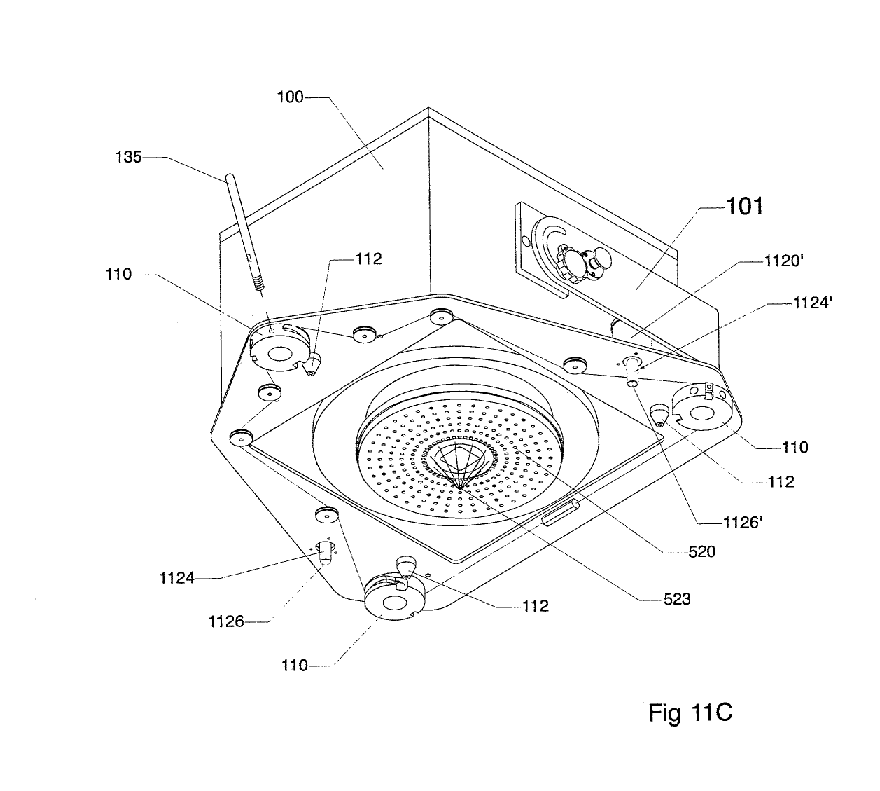

A third exemplary embodiment is described with the help of FIGS. 11A through 13C. FIG. 11A shows a test-head-mounted-DUT-adapter system for testing devices contained on wafer 510 that is held and positioned by wafer prober 500, which is the test peripheral. Enlarged views of the peripheral and test head sides of the docking apparatus are provided in FIGS. 11B and 11C respectively. Test head 100, which is held in cradle 101, is equipped with probe card 520 that includes needle-like probes 523 for directly making electrical contact with DUTs contained on wafer 510. Thus probe card 520 is the DUT adapter, and the system is a test-head-mounted-DUT-adapter system of the previously mentioned first subcategory where the DUTs are positioned before the test head is docked. Although it may presently be more common for a test system to locate the probe card within the peripheral and couple the test head to it through docking, this exemplary configuration may have advantages as it becomes more and more desirable to test many—if not all—devices on a wafer in parallel. In contrast to the previously described systems where the test head was docked upward from below, in this embodiment the test head is above the peripheral and docking motion is downward; that is, docking from above, which is typical in most wafer probing applications. The docking apparatus shown in FIG. 11A is a three point dock as was the case in the second exemplary embodiment in FIG. 9A; however, other configurations, such as a four point dock as described with respect to FIGS. 1A and 5A, could obviously be substituted. The goal of docking in the present embodiment is to bring probes 523 into positionally precise electrical contact with respective electrical contact pads (not visible in the scale of the figures) included in the DUTs. These contact pads are typically much smaller than the electrical contacts 123 provided on interface cards such as shown in the previous embodiments. Consequently, much higher degrees of docking accuracy and repeatability than those provided in prior art apparatus (e.g., as in FIG. 1A) are required.

In the third exemplary embodiment of FIG. 11A, two compliant feature units 1120 (not visible) and 1120′ are attached to face plate 106, which is in turn attached to test head 100. As in the second embodiment of FIG. 9A, these are configured to provide constrained positioning with respect to the docking plane. However, a further variation of the position-constraining features being incorporated is shown and will subsequently be described. Compliant feature unit 1120 is similar to the previously described compliant feature units 220, 220′ and 220″ of the previous two exemplary embodiments. Thus, it includes shaft 1124 with hemispherical end 1126 being similar to shafts 224, 224′ and 224″ having respective hemispherical ends 226, 226′ and 226″ described in reference to the previous embodiments. Also similar to previously described embodiments, Vee-block 1111 is attached to gusset plate 114, which is mounted on peripheral 500, so as to receive and make contact with hemispherical end 1126.

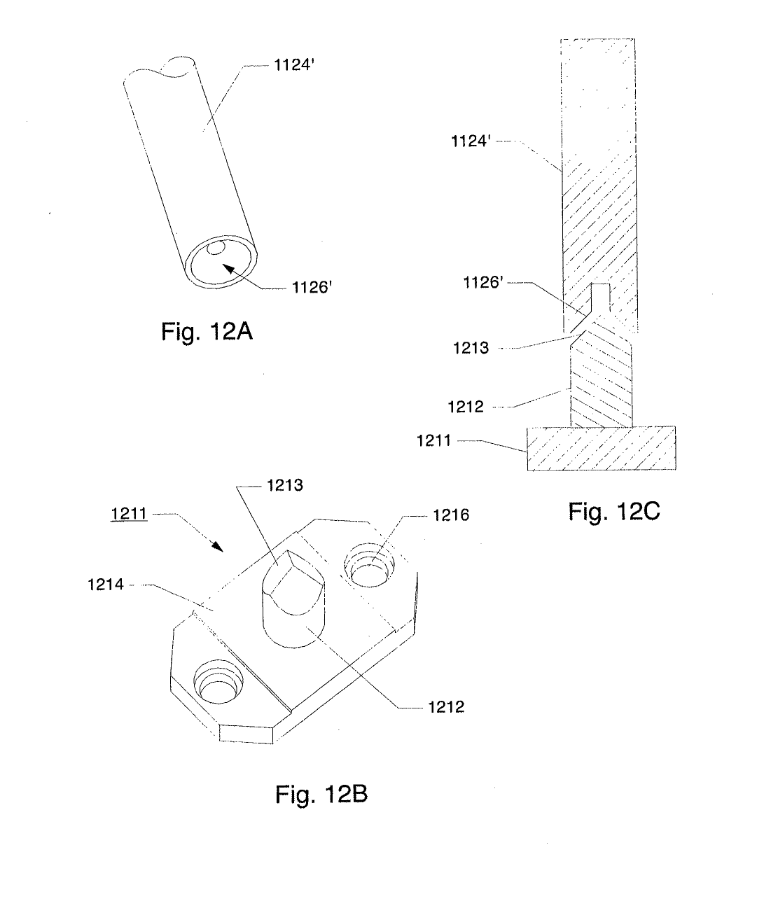

FIGS. 12A-12C (not necessarily to scale) illustrate aspects of shaft 1124′ of compliant feature unit 1120′ and its mating feature block 1211. Except for the feature included at the distal end of its shaft 1124′, compliant feature unit 1120′ is also similar to those described in reference to the previously described exemplary embodiments of FIGS. 5A and 9A. The distal portion of shaft 1124′ is shown in perspective in FIG. 12A. As thus shown, the distal end of its shaft 1124′ does not have a hemispherical shape; rather, it incorporates an axially-bored, countersunk hole, providing a cone-shaped opening 1126′. Feature block 1211, which is attached to gusset plate 114, is shown in a close-up perspective view in FIG. 12B. Feature block 1211 includes post 1212, which extends from its base region 1214. Base region 1214 includes counter-bored mounting screw holes 1216, which may be oversized to permit positional adjustments. Post 1212 includes tetrahedron-shaped (i.e., three-sided pyramid) feature 1213 at its distal end. Tetrahedron-shaped feature 1213 is formed such that the triangles forming its three exposed sides are congruent; and, also, such that the slopes of the lines formed by the intersections of its adjacent sides match the slope of the countersink bevel of cone-shaped opening 1126′ of shaft 1124′. The engagement of the tetrahedron-shaped feature 1213 within cone shaped opening 1126′ is illustrated in the cross-sectional view of FIG. 12C. This interaction provides three straight lines of contact (only two are visible in FIG. 12C), each line corresponding to the intersection of two triangular sides. Similar to the embodiment of FIG. 9A, the combination of the distal end of shaft 1124′ of compliant feature unit 1120′ and tetrahedron feature 1213 is used to establish and constrain the X-Y position of a point on test head 100 with respect to the docking plane, and the combination of compliant feature unit 1120 and Vee-block 1111 establishes the angular position of test head 100 with respect to the docking plane. The test head 100 is thus constrained in the three degrees of freedom with respect to the docking plane. The remarks made in the discussion of the second embodiment concerning the orientation of Vee-block 211″ apply also to the preferred orientation of Vee-block 1111. Further, as in the second exemplary embodiment, other shapes such as a ball shape or a pyramid with convex sides and edges, may be substituted for tetrahedran feature 1213. Also in this system no reference features comparable to reference features 131, 133 shown in the previously described systems have been included or considered. However, such reference features may be incorporated if desired.

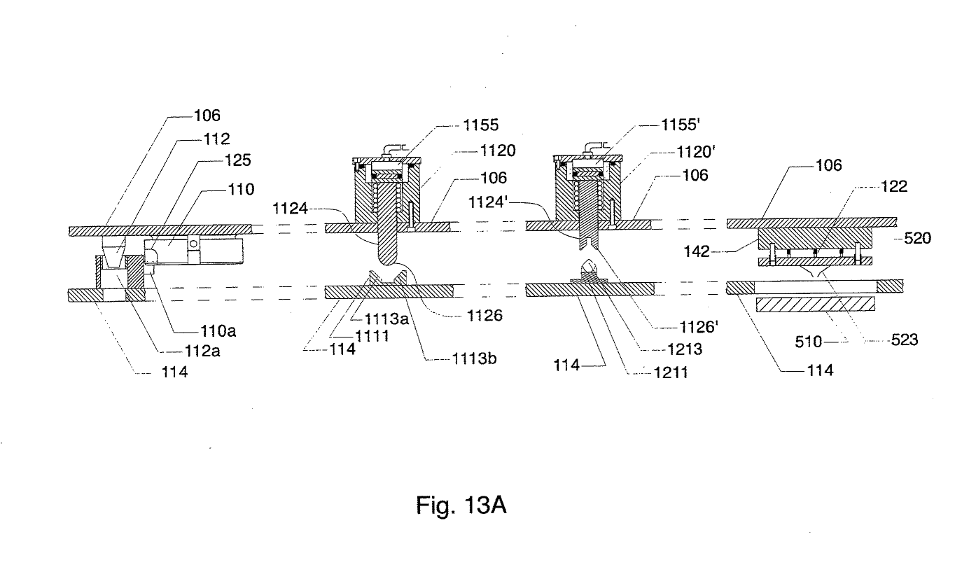

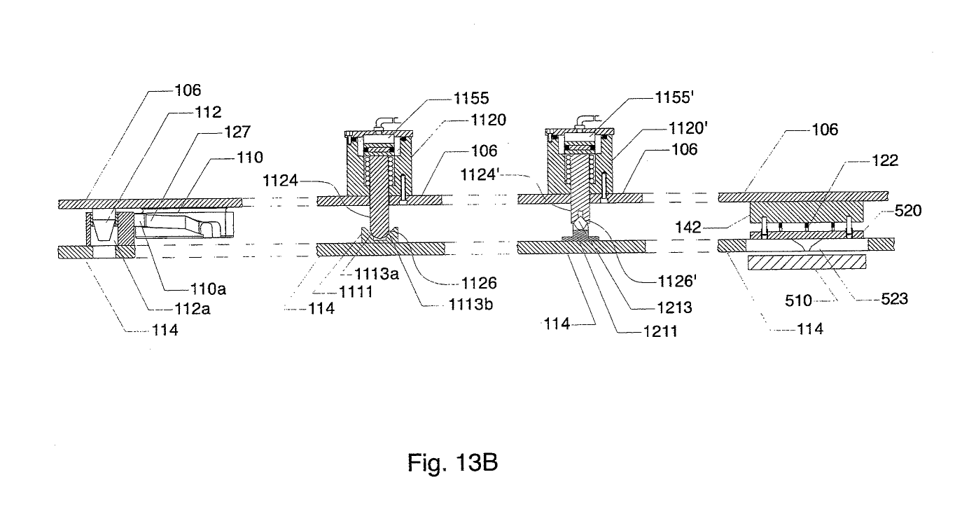

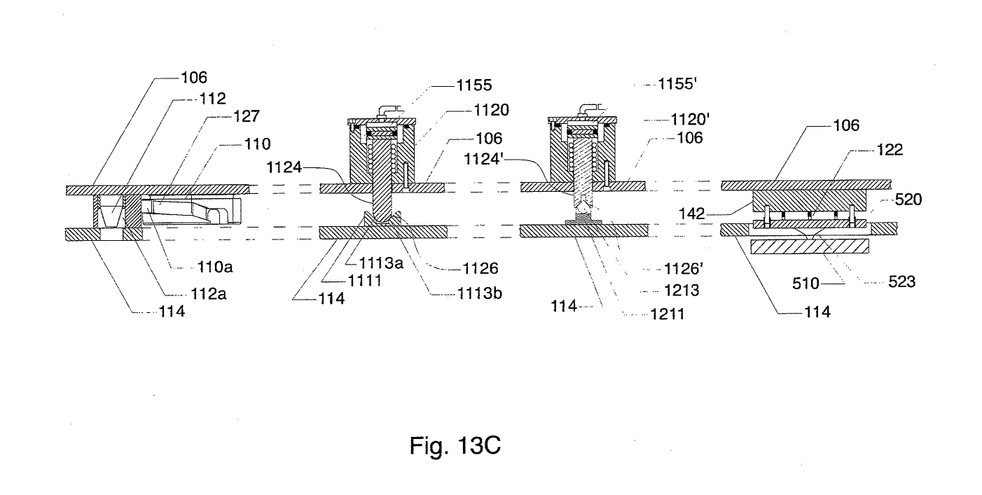

FIGS. 13A, 13B, and 13C illustrate selected steps in the docking of test head 100 to prober 500 in this third exemplary embodiment. As was the case in FIGS. 3A through 3D, these figures show side views of cam 110 and guide pin 112 mounted on a cross-section of face plate 106. A cross-section of gusset 116 attached to a cross-section of gusset plate 114 is also shown. The cross-section of gusset 116 is indicted by W-W in FIG. 2A. Also shown schematically, are wafer 510, probes 523, and probe card 520. Also shown in this series of figures are cross-sections of compliant feature units 1120 and 1120′ mounted to face plate 106 and respective groove block 1111 and tetrahedron feature block 1211, both mounted on gusset plate 114. Again, it is cautioned that these figures are not necessarily drawn to scale. Probe card 520 is shown connected by way of pogo pins 122 to a signal contact ring 142 which in turn is connected to the test head. This stack could be replaced by a single, one-piece unit if desired.

In relation to the docking sequence described with respect to FIGS. 8A through 8H, FIG. 13 A corresponds to FIG. 8C, FIG. 13B corresponds to FIG. 8F, and FIG. 13C corresponds to FIG. 8H. Thus, FIG. 13A shows a stage of coarse alignment, where cam follower 110a is entering cam opening 125. As in the previous embodiments, air is applied to compliant units 1120 and 1120′, urging shafts 1124 and 1124′ to fully extended positions. In this coarse alignment stage, hemispherical end 1126 is away from sides 1113a,b of Vee-block 1111, and cone-shaped opening 1126′ is away from tetrahedron 1213. Also probe tips 523 are well away from wafer 510

In FIG. 13B cam 110 has been rotated, drawing face plate 106, which is attached to test head 100 (not shown), closer to gusset plate 114, which is attached to prober 500 (also not shown). The interaction between cam slots 129 and cam followers 110a has established initial planarity with the docking plane and thus, desirably, between probe card 520 and wafer 510. In this position hemispherical end 1126 has made contact with sides 1113a,b of Vee-block 1111, and cone-shaped opening 1126′ has made contact with tetrahedron 1213. Air pressure is continuously supplied to compliant units 1120 and 1120′, urging these features into deterministic, position-constraining contact. Accordingly, probe card 520 has been aligned with respect to the two-dimensional space of the peripheral docking plane. Importantly, however, probes 523 are not yet in contact with the DUTs on wafer 510. Thus test head 100 and its attached probe card 520 with probes 523 have been positioned in five degrees of freedom with respect to DUT-containing wafer 510. Maintaining air pressure provides a preload force maintaining this alignment with respect to the docking plane as further cam 110 rotation brings the test head closer to its final docked position. During this motion, the compliance afforded by compliant feature units 1120 and 1120′, allow shafts 1124 and 1124′ to retract as necessary.

Thus, the final docked position, shown in FIG. 13C, is arrived at by further cam rotation. Cam followers 110a have reached the ends of their respective grooves 129, and cams 110 can not be further rotated. As previously described with respect to FIG. 8H, interaction between gussets 116 and face plate 106 have established final docked planarization and docked distance between test head 100 and prober 500. Probes 523 have come into contact with their respective contact elements on the DUTs included on wafer 510. In addition, fluid pressure has firmly held hemispherical shaft ends 1126 in contact with the sloping sides of Vee-block 1111 and cone-shaped opening 1126′ against tetrahedran 1213 during this final motion, maintaining the important position-constrained alignment to less than one one-thousandths inches with respect to the X-Y plane. During this motion, shafts 1124 and 1124′ have compliantly moved against the fluid pressure as the preload force is maintained.

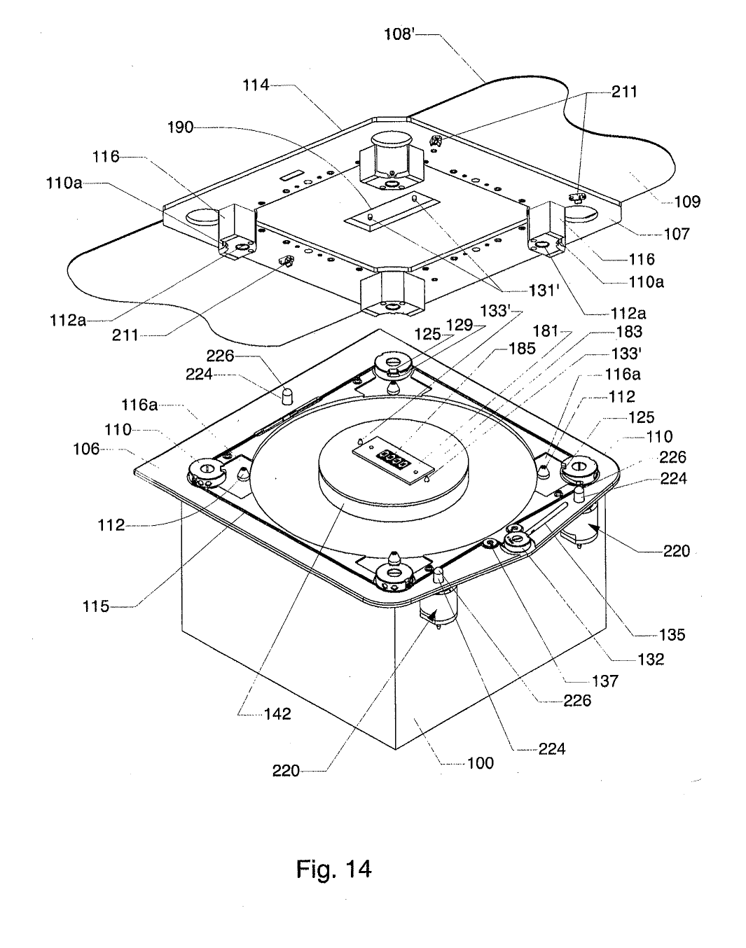

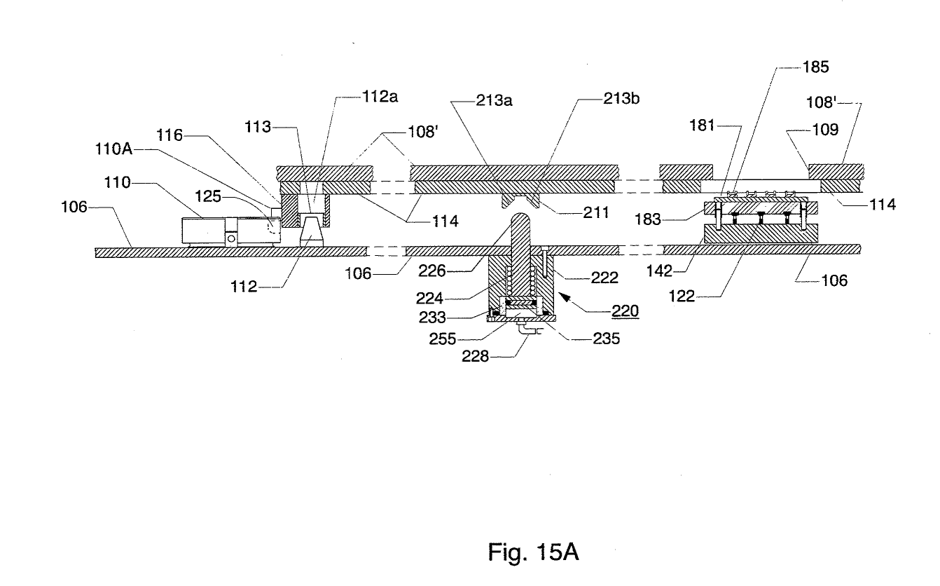

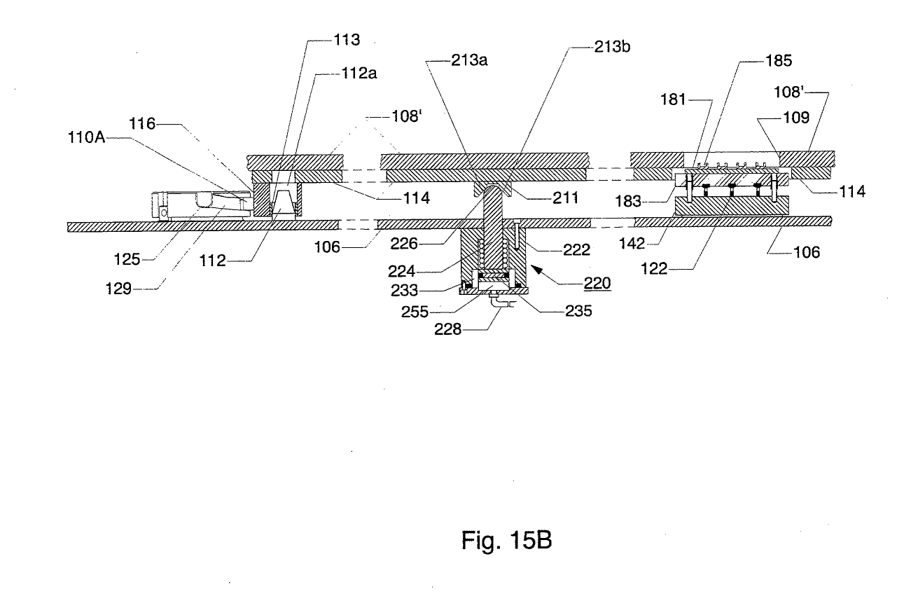

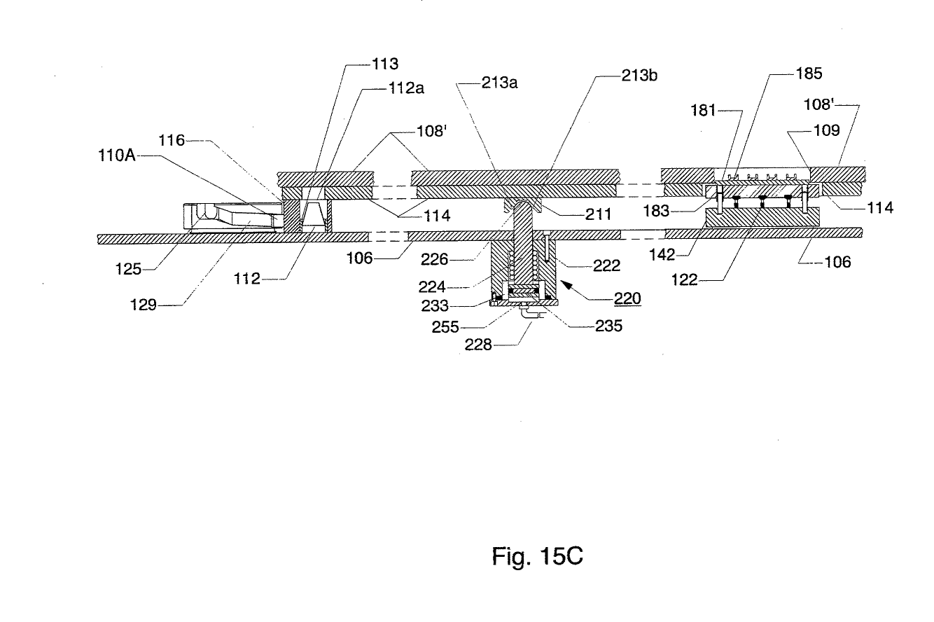

A fourth exemplary embodiment is described with reference to FIGS. 14-15C, which show a test-head-mounted-DUT-adapter system for testing packaged devices that are held and positioned in turn by packaged device handler 108′, which is the test peripheral. Test head 100 is equipped with socket card 183 that includes test sockets 185. When test head 100 and socket card 183 are properly positioned or docked, handler 108′ places packaged parts (DUTs) in turn into selected sockets for testing. Thus socket card 183 is the DUT adapter, and the system is a test-head-mounted-DUT-adapter system of the previously mentioned second subcategory wherein the DUTs are positioned for testing after the test head is docked. In contrast to the system of the third exemplary embodiment, this is currently a fairly common situation.

The docking apparatus used in the fourth exemplary embodiment incorporates ball-and-groove position-constraining features and is the same as that of the first exemplary embodiment, which was discussed in conjunction with FIGS. 5A through 8H. However, in the fourth exemplary embodiment, socket board 183 is coupled to signal ring 143, which is in turn coupled to test head 100. Thus, socket board 183 is mounted on test head 100; and the system, as stated above, is a test-head-mounted-DUT-adapter configuration. As shown, socket board 183 includes four test sockets 185 to enable four devices to be tested simultaneously. However, those familiar with the art will appreciate that the number of test sockets could be more or as few as one. Frame 181 surrounds test sockets 185, affording them a degree of protection. Opening 190 in surface 109 of peripheral 108 is sized to comfortably receive frame 181. Also peripheral 108′ includes reference features 131′, and corresponding test-head-mounted reference features 133′ associated with socket board 183. As discussed in the previous embodiments, the interaction between reference features 131′ and 133′ provides alignment to within a few thousandths of an inch between socket board 183 and peripheral 108′ with respect to the docking plane. However, the increasing numbers of and special density of contacts on packaged parts may demand much greater accuracy and repeatability. Thus, the goal of docking in this case is to position test sockets 185 within opening 190 with substantially greater accuracy and repeatability so that peripheral 108′ may automatically, repetitively and reliably insert packaged devices into test sockets 185 for testing.

The steps in docking with the fourth exemplary embodiment are similar to those described for the first exemplary embodiment in conjunction with FIGS. 8A through 8H. The positions at three of these steps for the fourth embodiment are shown in FIGS. 15A through 15C. As in previous figures, these show side views of cam 110 and guide pin 112 mounted on a cross-section of face plate 106. A cross-section of gusset 116 attached to a cross-section of gusset plate 114 is also shown. As before, the cross-section of gusset 116 is indicted by W-W in FIG. 2A. Also shown in this series of figures are cross-sections of a compliant feature unit 220 mounted to face plate 106 and its respective groove block 211 mounted on gusset plate 114. Also shown to the same relative scale, but schematically, are sockets 185, frame 181, socket board 183, signal contact ring 142, and device handler 108′ with opening 190. Socket board 183 is shown connected to signal contact ring 142 by way of pogo pins 122. If desired, this stacked structure could be replaced by a single unit. For simplicity, reference features 131′ and 133′ are not shown as these have no effect on operation once the apparatus has been calibrated and adjusted. Again, it is cautioned that these figures are not necessarily drawn to, scale.

In relation to the docking sequence described with respect to FIGS. 8A through 8H, FIG. 15 A corresponds to FIG. 8C, FIG. 15B corresponds to FIG. 8F, and FIG. 15C corresponds to FIG. 8H. Thus, FIG. 15A shows a stage of coarse alignment, where cam follower 110a is entering cam opening 125. As in the previous embodiments, air is applied to compliant unit 220, urging shaft 224 to a fully extended position. In this coarse alignment stage, hemispherical end 226 is away from sides 213a,b of Vee-block 211. Also test sockets are well away from device handler 108′.

In FIG. 15B, cam 110 has been rotated, drawing face plate 106, which is attached to test head 100 (not shown), closer to gusset plate 114, which is attached to device handler 108′. As in the other embodiments, the interaction between cam slots 129 and cam followers 110a has established initial planarity with the peripheral docking plane, i.e., between socket board 183 and device handler 108′. In this position, hemispherical end 226 has made contact with sides 213a,b of Vee-block 211. Air pressure is continuously supplied to compliant units 220, urging these features into deterministic, position-constraining contact. Accordingly, socket board 183 has been aligned with respect to the two-dimensional space of the docking plane. Thus test head 100 and its attached socket board 183 with sockets 185 have been positioned in five degrees of freedom with respect to device handler 108′. Maintaining air pressure will provide a preload force maintaining this alignment with respect to the docking plane as further cam 110 rotation brings the test head closer to its final docked position. During this motion, the compliance afforded by compliant feature units 220, allow shafts 224 to retract as necessary.

Thus, the final docked position, shown in FIG. 15C, is arrived at by further cam rotation. Cam followers 110a have reached the ends of their respective grooves 129, and cams 110 can not be further rotated. As previously described with regards to FIG. 8H, interaction between gussets 116 and face plate 106 have now established final docked planarization and docked distance between test head 100 and device handler 108′. In addition, fluid pressure has firmly held hemispherical shaft ends 1126 in contact with the sloping sides 213a,b of Vee-block 211 during this final motion, maintaining the important precision alignment to less than 0.001 inches with respect to the X-Y plane. During this motion, shafts 224 have compliantly moved against the fluid pressure as the resulting preload force is maintained. Thus, test sockets 185 are now precisely and constrainedly positioned in relation to device handler 108′ in all six degrees of spatial freedom as desired.

The four exemplary embodiments (illustrated in FIGS. 5A, 9A, 11A, and 14) all serve to illustrate a method of docking a test head to a peripheral. It is to be observed that the method and invention provides an improvement to and builds upon prior art docking technology. Those familiar with the art will recognize that this method may be readily adapted to virtually any style of docking apparatus, many of which have been mentioned previously herein. In some cases, as will be further recognized by those familiar with art, the method may be applied by straightforward addition of apparatus to existing docks. In other cases, particularly those that utilize non-compliant kinematic couplings, it will be apparent that relatively straightforward modifications to existing hardware may be necessary.

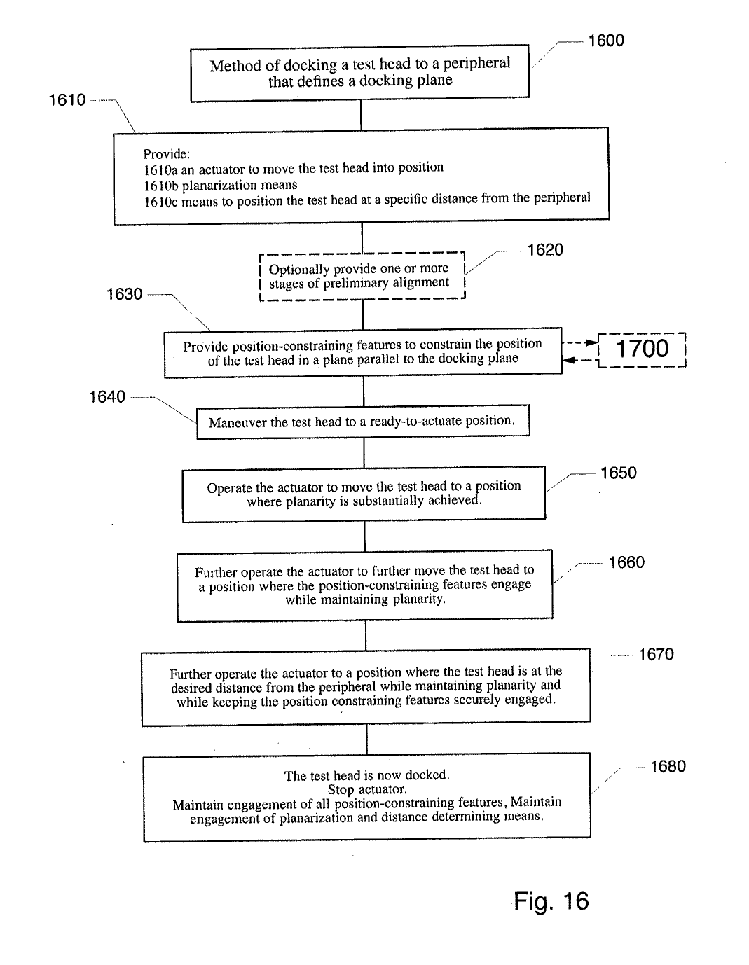

FIG. 16 provides a flow chart of this method, and it is intentionally presented in a manner that is independent of the particular type of docking apparatus. As depicted in FIG. 16, the general method of docking 1600 begins with providing certain necessary apparatus. It is assumed that a peripheral docking plane (as previously described) is defined by the peripheral and a test-head docking plane is associated with the test head. Step 1610 provides docking system components that may be found in the prior art. Thus in step 1610, at sub-step 1610a, it is specified to provide an actuation mechanism to move the test head into the docked position. This may be essentially any prior art actuation scheme including both linear and circular cams as well as mechanisms that directly attach to and pull or push the test head. It is also necessary at sub-step 1610b to provide a means of planarizing the test head docking plane with respect to the docking plane of the peripheral. This requires controlling two rotational degrees of freedom, pitch and roll. For example, in cam-actuated docks, this is typically accomplished with the interaction between the cam followers and the cam slots. Other techniques are known in other styles of docks. Also, step 1610, at sub-step 1610c, specifies that it is necessary to provide a means to position the test head at a specific, pre-specified distance, the “docked distance,” from the peripheral. This provides control of a third degree of freedom. As an example, in cam-actuated docks the docked distance may be established by the location of the terminal portion of the cam slot with respect to the location of the cam follower, as has been previously described. This may be augmented by arranging gussets so that they fit tightly between the docked test head and peripheral as has also been described in the previous exemplary embodiments. In other schemes, such as the previously described manipulator-driven docking, stop blocks, for example, may be used in conjunction with sensors to determine the docked distance.

Step 1620 is an optional step and is thus drawn with dashed lines. In this step, means for preliminary alignment in at least three degrees of freedom corresponding to motion in a plane parallel to the docking plane are provided. These may be incorporated to aid in protecting the delicate electrical contacts and/or to provide preliminary alignment to within a few thousandths of an inch. Typical examples include prior art guide pins and receptacles as well as gussets interacting with cams. In other examples, relatively long guide pins fitted to corresponding receptacles could approximately satisfy this step and sub-step 1610b simultaneously. Strictly speaking, this step is not necessary for practicing the invention; however, it is one that many users may prefer. It is to be noted that this step is necessary in prior art systems, and the prior art may be used to accomplish it.

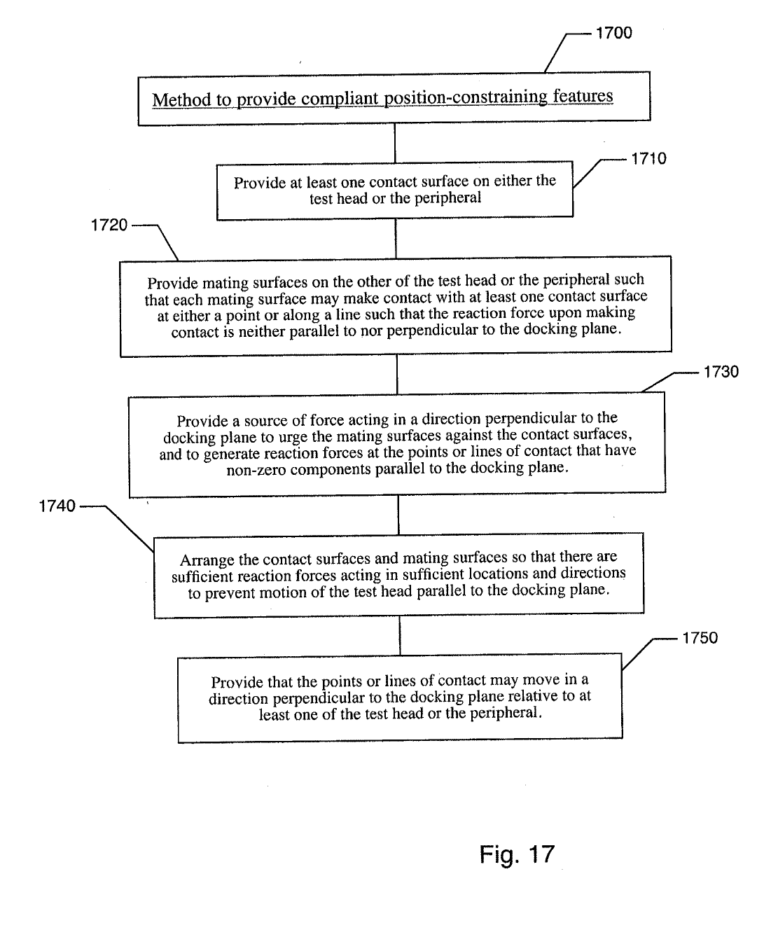

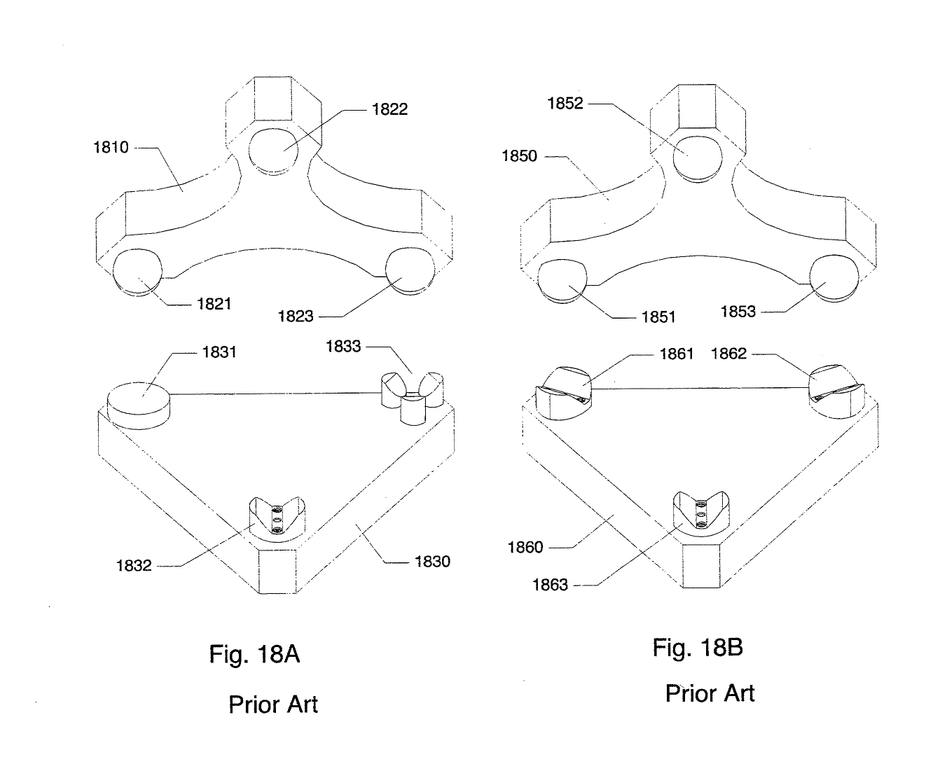

Step 1630 provides apparatus to precisely constrain the position of the test head in the three degrees of motion freedom in a plane parallel to the peripheral docking plane. In preferred embodiments, exact-constraint apparatus such as that which has been previously described would be utilized. FIG. 17 provides a flow chart illustrating a method of providing such apparatus, which will be described in more detail later. However, it is contemplated that alternatives such as tightly fitting pins and receptacles could be substituted within the spirit of the invention; however, these may not be as precise or as repeatable and may further require substantially increased force for dock actuation. In any case, the apparatus to be provided may include pairs of engagable features, with one member of each pair being attached to the peripheral, and the other member being attached to the test head. The features are disposed so that the two members of each pair may engage one another to provide a constrained position of the test head relative to the peripheral in the three degrees of freedom in a plane. Further, at least one member of each pair of features is mounted so that it is compliantly movable in a direction that is substantially perpendicular to the docking plane. This step is new and not found in the prior art.

In step 1640, which is adapted from the prior art, the test head is maneuvered to a position where the actuator may be engaged to further move it into its docked position. In this position, the feature pairs of the position-constraining apparatus provided in step 1630 are not necessarily engaged. This maneuvering may be done with the assistance of a test head manipulator. In this position, the test head is approximately aligned in all degrees of freedom except one, namely, its final docked distance from the peripheral.

In step 1650, the actuator is operated moving the test head from the ready-to-actuate position to a position closer to the peripheral. The means of planarization provided at sub-step 1610b establish a substantially co-planar relationship between the test head docking plane and the peripheral docking plane. The position-constraining features provided in step 1630 are not in play at this position. It is to be noted that the planarization may occur at the ready to actuate position of step 1640; however, in many prior art systems, a relatively small, initial amount of motion of the actuation apparatus refines the planarity.

Step 1660 provides for continuing to operate the actuator from the position of step 1650 to move the test head still closer to the peripheral to a position where the respective members of the feature pairs of the position-constraining features are engaged. The planarity of the test head established at step 1650 is maintained throughout this step. If the system is a peripheral-mounted DUT adapter system, the position of the test head is far enough from the peripheral so that the electrical contacts of the test-head-side electrical interface and those of the peripheral-mounted DUT adapter are separated. If the system is a test head mounted DUT adapter system where the peripheral has positioned the DUT for testing prior to docking, the position of the test head in this step is far enough from the peripheral so that the electrical contacts are separated from the DUT. This step is not found in the prior art.

Step 1670 provides for continuing to operate the actuator to move the test head to its desired docked distance from the peripheral as determined by the apparatus provided at sub-step 1610c. During this motion, planarity is maintained by the planarization means provided at sub-step 1610b. Importantly, during this motion, the position-constraining features provided at step 1630 remain securely engaged. Thus, precise alignment is maintained in five degrees of freedom as this motion occurs. Importantly, motion in a plane parallel to the docking plain is essentially non-existent due to the interactions of the position-constraining features. Due to the compliant motion that is available to at least one member of each position-constraining feature pair, engagement between members of each feature pair is maintained without relative motion between the pair members. During the motion of this step, the respective electrical contacts of the test head electrical interface and those of the peripheral-mounted DUT adapter system become conjoined. Also the electrical test contacts of a test-head-mounted DUT adapter system may become conjoined with the DUT if the system is of the type where the DUT is positioned prior to docking.

At step 1680 the actuator is no longer operated and the system is docked. The actuator remains in a position to maintain the docked position. The position-constraining features remain securely engaged while docked as do the means establishing the docked planarization and docked distance.

In the previously described exemplary embodiments, a number of compliant position-constraining features are described; however, the invention is not limited to these specific examples. For example, numerous alternatives may be utilized in the practice of the invention by following the teachings of the numerous previously mentioned and listed references. FIG. 17 illustrates a generic method 1700 of approach to providing compliant position-constraining features suitable for fulfilling step 1630 of the previously described method of docking. The steps in FIG. 17 are not necessarily performed in the order given. Indeed two or more steps may be performed in parallel, and it is to be expected that iteration over a number of steps may be necessary in arriving at a solution.

To begin, we recall that position constraint is a result of one set of surfaces contacting a second set of surfaces at discrete points or discrete lines of contact. Thus, at step 1710 it is specified to provide a set of “contact surfaces” on either the test head or the peripheral. For example, these may correspond to the sloping sides 213a,b of the Vee-blocks 211 mounted on the peripheral 108 of the exemplary system illustrated in FIG. 5A. In this case there are six surfaces in the set. However, in the exemplary case derived from the Kelvin clamp illustrated in FIG. 9A, only three such surfaces are attached to the peripheral; namely an inverted cone 313 and the two sides 213a,b of the single V-block 211″. It is contemplated that it may be possible to satisfy this step with just one surface, although it would likely be quite complex and impractical.

Step 1720 provides “mating surfaces” on the other system component to make contact with the contact surfaces provided in step 1710. It is specified that the contacts should be made at discrete points or along discrete lines. The step further requires that a reaction force generated by the act of holding the surfaces in contact with one another acts along a line that is not perpendicular to the peripheral docking plane. Thus, the tangent plane to a contact surface and its mating surface at a point where they make contact may not be parallel to the docking plane. In brief, the contact surface and the mating surface must be at a bevel angle with respect to the docking plane. In relation to the examples of contact surfaces previously provided, their corresponding mating surfaces would include the hemispherical ends 226, 226′ 226″ of shafts 224, 224′ & 224″ of compliant feature units 220, 220′ & 220″ in the first and second exemplary embodiments of FIGS. 5A and 9A.

It is seen that subsets of the contact surfaces and subsets of the mating surfaces may be arranged in pairs forming engagable pairs of position constraining features.

A source of force for pressing the mating surfaces and the contact surfaces into firm contact with one another is provided in step 1730. This is frequently called a preload force as previously mentioned. This force, or at least a major component of it, is preferably directed perpendicularly to the docking plane. The reaction force to this applied force at the points or lines of contact between the contact surfaces and the mating surfaces must have components parallel to the docking plane in order to constrain position and motion. In the previously described exemplary embodiments this force is derived from the fluid pressure provided to cylinders 255. Other alternatives could also be applied, for example U.S. Pat. No. 6,678,944 to Slocum teaches that spring mechanisms could be used or that the surfaces themselves could be resilient, spring-like structures. Any such alternatives are within the spirit of the invention.

The location and orientation of the contact surfaces and mating surfaces is considered in step 1740. These must be arranged so that there are sufficient docking-plane-parallel reaction forces that act in locations and directions sufficient to prevent motion of and maintain the position of the test head in all three degrees of freedom parallel to the docking plane. It is also preferred that locations and orientations be selected to provide reasonable stability against unexpected externally applied forces or events. Further, it is preferred that there are no redundancies in reaction forces that would cause the system to be over-constrained, which could lead to non-repeatable behavior. As to advice on performing this and other steps, the reader is directed to the considerable literature that has been previously mentioned and listed.

Compliance is provided in step 1750, which specifies that at least one surface of a pair of contactable contact and mating surfaces has the ability to move in a direction that is substantially perpendicular to the docking plane. This is to allow the points or line of contact to move relative to the test head or peripheral as the two are moved together by the docking actuator. In the exemplary embodiments this capability is provided by the movable piston 235 within cylinder 255. U.S. Pat. No. 6,678,944 also teaches providing this capability by way of a movable piston within a cylinder. This patent further teaches fabricating one of the surfaces in a spring-like fashion to provide this capability. The teachings of the '944 patent may therefore also be used in fulfilling this step. Step 1750 may be combined with step 1730 because the means of force generation is closely related to the compliance means. However, separation into two steps provides individual focus on the two important issues.

The invention as described by the foregoing exemplary embodiments and methods provides an improvement to state-of-the-art and contemporary test head docking schemes. First, the invention provides two sets of features for controlling the docked position of the test head relative to the peripheral in all six degrees of spatial freedom. The first set, taken from the prior art, is exemplified by the use of gussets and or the interactions between cams and cam followers to control the three degrees of freedom associated with the docked planarity and docked distance of the test head. The second set, derived from the field of exact-constraint or kinematic coupling design, controls and constrains the remaining three degrees of freedom associated with the docked position of the test head in a plane that is parallel to the docking plane defined by the peripheral. The second set has been exemplified by ball and groove techniques and by modified Kelvin clamp techniques; however, as has been stated, other forms of exact-constraint coupling features are known and may be readily substituted. Because the position constraining features of the second set are only required to constrain three degrees of freedom, a full six-degree of freedom kinematic coupling is not necessary, which is demonstrated by the arrangements of the second and third exemplary embodiments. Further, the second set of features incorporates compliance that operates in a direction that is perpendicular to the docking plane. This allows the second set of features to become engaged at a distance that is away from the desired docked distance and to remain engaged, without relative motion between mated pairs of features, while the test head is moved into its final docked position. Such apparatus is then combined with the previously described method, provides greatly improved accuracy and repeatability of docking that is demanded by the advances in testing requirements for present and future integrated circuits.

The invention is not restricted to the specific structures of the exemplary embodiments. As has been mentioned, the invention is readily applicable to other forms, styles, and configurations of docking apparatus. It is also to be understood that while the exemplary embodiments show certain components on one of the peripheral or test head and corresponding components on the other of the test head or peripheral, the positions of some or all of the components could be reversed or interchanged. It is to be further understood that alternative embodiments of a compliant feature unit could be readily adapted to the present invention. For example, as has been previously mentioned, the Slocum U.S. Pat. No. 5,678,944 describes a compliant unit that incorporates internal springs rather than a pressurized fluid. Also the '944 patent shows compliant features of various types fabricated of deformable, resilient structures which could also be adapted to the present invention. As has also been previously mentioned, numerous alternative forms of exact-constraint coupling features are known and described in the literature. These provide a wide variety of alternatives to the basic forms, which have been incorporated in the exemplary embodiments. Additionally, commercial suppliers of components for implementing position-constraining features, suitable for practicing the invention, have been identified.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of docking a test head to a peripheral, the test head having a test head docking plane, at least one component of an alignment feature and at least one component of a position-constraining feature, and the peripheral having a peripheral docking plane, at least one complimentary component of the alignment feature and at least one complimentary component of the position-constraining feature, the method comprising the steps of:
positioning the test head relative to the peripheral in a first position with the test head docking plane substantially parallel and spaced from the peripheral docking plane;
moving the test head toward the peripheral, with the planes remaining substantially parallel, to a second position wherein the complimentary components of the position-constraining feature engage one another in a given relative positional relationship wherein the test head and peripheral are restrained from motion relative to one another in a direction parallel to the planes; and
moving the test head toward the peripheral, with the planes remaining substantially parallel, to a third position wherein the complementary components of the alignment feature engage to maintain the planes at a docked distance from one another, the complementary components of the position-constraining feature maintaining the given relative positional relationship during such further movement.

2. The method of claim 1 wherein the step of positioning the test head relative to the peripheral includes preliminary alignment of the complementary alignment features and the complementary position-constraining features.

3. The method of claim 1 wherein one of the components of the position-constraining features defines at least one contact surface and the complementary component of the position-constraining feature defines a mating surface which makes contact with a corresponding contact surface at either point or line contact such that a reaction force upon making contact is not parallel or perpendicular to the docking planes.

4. The method of claim 1 wherein the position-constraining feature includes a source of force acting on one of the components of the position-constraining feature in a direction perpendicular to the docking planes such that the point or line of contact has a non-zero force component parallel to the docking planes.

5. The method of claim 1 wherein in the second position, electrical contacts on the test head are separated from electrical contacts on the peripheral.

6. The method of claim 1 wherein the complementary components of the position-constraining features remain in the given relative positional relationship while the test head remains in its docked position.

7. The method of claim 1 wherein electrical contacts on the peripheral are on one of a probe card, a socket card, and a device under test.

8. An apparatus for docking a test head having a test head docking plane to a peripheral having a peripheral docking plane, the apparatus comprising:
at least one alignment feature including complimentary alignment components, one associated with the test head and the other associated with the peripheral device, the alignment components configured such that engagement therebetween controls the distance and the planar orientation of the docking planes relative to one another; and
at least one position-constraining feature including complementary constraining components, one associated with the test head and the other associated with the peripheral, one of the constraining components being compliant in a direction perpendicular to the docking planes,
wherein the constraining components are configured to engage one another in a given relative positional relationship when the docking planes are at a first relative position to one another wherein electrical contacts on the test head are separated from electrical contacts on the peripheral, the engaged constraining components restraining the test head and peripheral from motion relative to one another in a direction parallel to the docking planes, and
wherein the constraining components remain engaged, without moving relative to one another, while the test head is moved to a docked position wherein the electrical contacts on the test head and the peripheral are conjoined.

9. The apparatus of claim 8 further comprising a force generating unit configured to urge the compliant constraining component toward the other constraining component.

10. The apparatus of claim 9 wherein the force generating unit provides a force over a given range of motion of the compliant constraining component.

11. The apparatus of claim 9 wherein the force generating unit is fluidly operated.

12. The apparatus of claim 8 comprising three position-constraining features, each of the position-constraining features including a Vee-groove as one of the constraining components and a spherical member as the complementary constraining component.

13. The apparatus of claim 8 comprising two position-constraining features, the complementary components of one of the position-constraining features defining two points or lines of contact to constrain a point of the test head in a planar direction and the complementary components of the other position-constraining feature defining one point or line of contact to constrain rotational movement of the test head.
